(19) United States
(12) Patent Application Publication
(10) Pub. No.: US 2025/0157328 A1
(43) Pub. Date: May 15, 2025

(54) APPARATUS AND METHOD FOR DETECTING SPEEDING VEHICLES BASED ON IMAGE ANALYSIS

(71) Applicant: SK Planet Co., Ltd., Seongnam-si (KR)

(72) Inventors: Yeong Hyeon PARK, Suwon-si (KR); Myung Jin KIM, Seongnam-si (KR)

(21) Appl. No.: 18/935,429

(22) Filed: Nov. 2, 2024

(30) Foreign Application Priority Data
Nov. 9, 2023 (KR) 10-2023-0154336
Nov. 30, 2023 (KR) 10-2023-0171691
Nov. 30, 2023 (KR) 10-2023-0171694

(51) Int. Cl. G08G 1/054; G06T 7/20; G06T 7/70; G06V 20/52; G08G 1/017; H04N 7/18

(52) U.S. Cl. CPC G08G 1/054; G06T 7/20; G06T 7/70; G06V 20/52; G08G 1/0175; H04N 7/183; G06T 2207/10016; G06T 2207/20081; G06T 2207/30252; G06V 2201/08

(57) ABSTRACT

Various embodiments provide an apparatus and method capable of detecting a speeding vehicle by only analyzing an image captured by a camera without the need to install and operate a speedometer. In this case, the image for detecting a speeding vehicle may be a streaming image or a CCTV image captured and transmitted by an imaging device such as a fixed CCTV camera device or a mobile CCTV camera device.

### CROSS-REFERENCE TO RELATED APPLICATIONS

The present application is based upon and claims the benefit of priority to Republic of Korea Patent Application Nos. 10-2023-0154336, filed on Nov. 9, 2023, 10-2023-0171691, filed on Nov. 30, 2023, and 10-2023-0171694, filed on Nov. 30, 2023, which are incorporated by reference herein in their entirety.

### TECHNICAL FIELD

The present disclosure relates to a technology for detecting speeding vehicles, and more specifically, to an apparatus and method for detecting speeding vehicles by analyzing images of vehicles driving on a road.

### BACKGROUND ART

Typically, in order to prevent speeding, speedometers are installed on the road to measure the speed of vehicles driving on the road. If the speed of a specific vehicle is measured to exceed the designated speed, the vehicle is photographed through a camera installed with the speedometer and a penalty is imposed.

This method of detecting speeding vehicles has the problem of high installation and maintenance costs because it requires the installation and operation of speedometers and cameras at the same time.

### SUMMARY

The present disclosure is intended to provide an apparatus and method capable of detecting a speeding vehicle by only analyzing an image captured by a camera without the need to install and operate a speedometer. In this case, the image for detecting a speeding vehicle may be a streaming image or a CCTV image captured and transmitted by an imaging device such as a fixed CCTV camera device or a mobile CCTV camera device.

According to an embodiment of the present disclosure, a speeding vehicle detection method may include: by an image processor, receiving a streaming video of a road from an imaging device; by an object detector, detecting a vehicle through a bounding box in a plurality of frames of the streaming video by using a detection model; by a speed analyzer, calculating a speed of the detected vehicle by analyzing a movement of the bounding box in frames in which the vehicle is detected from among the plurality of frames; and by the speed analyzer, determining whether the detected vehicle is speeding based on the calculated speed.

In the method, calculating a speed of the detected vehicle may include: by the speed analyzer, calculating a travel distance of the vehicle by using a movement distance of the bounding box from a first frame to a last frame among the frames in which the vehicle is detected; by the speed analyzer, calculating a travel time of the vehicle by applying a frame rate of the streaming video to a number of the frames in which the vehicle is detected; and by the speed analyzer, calculating the speed of the vehicle based on the calculated travel distance and travel time.

In the method, calculating a travel distance may include: by the speed analyzer, applying a previously derived homography to convert center coordinates of the bounding box in each of the first and last frames among the frames in which the vehicle is detected into coordinates in a ground map; and by the speed analyzer, calculating a distance between the converted coordinates in the ground map as the travel distance of the vehicle.

In the method, the travel distance may be calculated according to Equation below,

$$D = \sqrt{{( {x}_{2} - {x}_{1} )}^{2} - {( {y}_{2} - {y}_{1} )}^{2}}$$

where D represents the travel distance of the vehicle, x₁ and y₁ are ground coordinates converted from the center coordinates of the bounding box in the first frame among the frames in which the vehicle is detected, and x₂ and y₂ are ground coordinates converted from the center coordinates of the bounding box in the last frame among the frames in which the vehicle is detected.

The method may further include: before receiving the streaming video, by a relationship deriver, preparing an image and a ground map corresponding to the image, the image containing a road captured by a camera of the imaging device and being composed of a pixel coordinate system, and the ground map expressing a road indicated by the image and having a two-dimensional coordinate system based on a metric system corresponding to an actual size; and by the relationship deriver, deriving a homography that converts one coordinates of the image into corresponding coordinates of the ground map, by using the image and the ground map.

In the method, when Equation below is satisfied

$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ]$$

where hᵢⱼ (i≤1, j≤3) denotes a matrix representing the homography, the relationship deriver may derive a matrix that minimizes Equation below as the homography

$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2}$$

where (xᵢ, yᵢ) represents the coordinates of the image, and (xᵢ′, yᵢ′) represents the coordinates of the ground map.

The method may further include: before receiving the streaming video, by a model generator, preparing learning data including an image and a label, the image containing a vehicle, and the label being a ground-truth box indicating an area occupied by the vehicle in the image; by the model generator, inputting the image into a detection model whose learning is uncompleted; by the detection model, detecting a bounding box indicating the area occupied by the vehicle within the image through a plurality of operations for applying untrained inter-layer weights to the input image; by the model generator, calculating a loss indicating a difference between the detected bounding box and the ground-truth box; and by the model generator, performing optimization to modify the weight of the detection model so that the loss is minimized.

According to an embodiment of the present disclosure, a speeding vehicle detection apparatus may include: an image processor receiving a streaming video of a road from an imaging device; an object detector detecting a vehicle through a bounding box in a plurality of frames of the streaming video by using a detection model; and a speed analyzer calculating a speed of the detected vehicle by analyzing a movement of the bounding box in frames in which the vehicle is detected from among the plurality of frames, and determining whether the detected vehicle is speeding based on the calculated speed.

In the apparatus, the speed analyzer may calculate a travel distance of the vehicle by using a movement distance of the bounding box from a first frame to a last frame among the frames in which the vehicle is detected, calculate a travel time of the vehicle by applying a frame rate of the streaming video to a number of the frames in which the vehicle is detected, and calculate the speed of the vehicle based on the calculated travel distance and travel time.

In the apparatus, the speed analyzer may apply a previously derived homography to convert center coordinates of the bounding box in each of the first and last frames among the frames in which the vehicle is detected into coordinates in a ground map, and calculate a distance between the converted coordinates in the ground map as the travel distance of the vehicle.

In the apparatus, the travel distance may be calculated according to Equation below

$$D = \sqrt{{( {x}_{2} - {x}_{1} )}^{2} - {( {y}_{2} - {y}_{1} )}^{2}}$$

where D represents the travel distance of the vehicle, x₁ and y₁ are ground coordinates converted from the center coordinates of the bounding box in the first frame among the frames in which the vehicle is detected, and x₂ and y₂ are ground coordinates converted from the center coordinates of the bounding box in the last frame among the frames in which the vehicle is detected.

The apparatus may further include: a relationship deriver preparing an image and a ground map corresponding to the image, the image containing a road captured by a camera of the imaging device and being composed of a pixel coordinate system, and the ground map expressing a road indicated by the image and having a two-dimensional coordinate system based on a metric system corresponding to an actual size, and deriving a homography that converts one coordinates of the image into corresponding coordinates of the ground map, by using the image and the ground map.

In the apparatus, when Equation below is satisfied

$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ]$$

where hᵢⱼ (i≤1, j≤3) denotes a matrix representing the homography, the relationship deriver may derive a matrix that minimizes Equation below as the homography

$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2}$$

where (xᵢ, yᵢ) represents the coordinates of the image, and (xᵢ′, yᵢ′) represents the coordinates of the ground map.

The apparatus may further include: a model generator preparing learning data including an image and a label, the image containing a vehicle, and the label being a ground-truth box indicating an area occupied by the vehicle in the image, inputting the image into a detection model whose learning is uncompleted, when the detection model detects a bounding box indicating the area occupied by the vehicle within the image through a plurality of operations for applying untrained inter-layer weights to the input image, calculating a loss indicating a difference between the detected bounding box and the ground-truth box, and performing optimization to modify the weight of the detection model so that the loss is minimized.

According to an embodiment of the present disclosure, a vehicle speed detection apparatus may include: a server communication circuit; and a server processor functionally connected to the server communication circuit and configured to: obtain a first CCTV captured image that does not include a vehicle, set a specific section including a start position and an end position of a lane in the first CCTV captured image, store distance information of the specific section through an external input, obtain a second CCTV captured image that includes a vehicle, measure a travel time of a vehicle object from the start position to the end position by tracking the vehicle object in the second CCTV captured image to, and calculate speed information of the vehicle based on the measured time and the distance information.

In the apparatus, the server processor may be configured to: select a start reference point object corresponding to the start position and an end reference point object corresponding to the end position from the first CCTV captured image, and set a section between the start reference point object and the end reference point object as the specific section.

According to an embodiment of the present disclosure, a vehicle speed detection apparatus may include: a server communication circuit; and a server processor functionally connected to the server communication circuit and configured to: obtain CCTV captured images, select frames of the CCTV captured images at a first interval according to a predefined frame sampling rate, detect a plurality of frames including at least one reference object having an end that matches with a designated part of a vehicle object among the frames selected at the first interval, detect a travel time of the vehicle object by identifying intervals of the plurality of frames, and detect speed information of the vehicle object by using pre-stored distance information between the at least one reference object and the travel time of the vehicle.

In the apparatus, the server processor may be configured to: detect the travel time of the vehicle object based on a frame interval between a first frame including a first reference object having one end matching with the designated part of the vehicle object and a second frame including the first reference object having another end matching with the designated part of the vehicle object, and detect the speed information of the vehicle object by using pre-stored length information of the first reference object and the travel time of the vehicle.

In the apparatus, the server processor may be configured to: detect the travel time of the vehicle object based on a frame interval between a first frame including a first reference object having one end matching with the designated part of the vehicle object and a second frame including a second reference object having one end matching with the designated part of the vehicle object, and detect the speed information of the vehicle object by using pre-stored distance information between the first reference object and the second reference object and the travel time of the vehicle.

In the apparatus, the server processor may be configured to: adjust the frame sampling rate in case of failing to detect the reference object having one end matching with the designated part of the vehicle object, select frames of the CCTV captured images at a second interval narrower than the first interval based on the adjusted frame sampling rate, and detect the vehicle object and the at least one reference object for the frames selected at the second interval.

In the apparatus, the server processor may be configured to: transmit a control signal to a CCTV camera device providing the CCTV captured images to increase a captured speed by a designated speed in case of failing to detect the reference object having one end matching with the designated part of the vehicle object.

According to an embodiment of the present disclosure, a vehicle speed detection method performed by a server processor of the vehicle speed detection apparatus may include obtaining a first CCTV captured image that does not include a vehicle; setting a specific section including a start position and an end position of a lane in the first CCTV captured image; storing distance information of the specific section through an external input; obtaining a second CCTV captured image that includes a vehicle; measuring a travel time of a vehicle object from the start position to the end position by tracking the vehicle object in the second CCTV captured image to; and calculating speed information of the vehicle based on the measured time and the distance information.

In the method, setting a specific section may include selecting a start reference point object corresponding to the start position and an end reference point object corresponding to the end position from the first CCTV captured image; and setting a section between the start reference point object and the end reference point object as the specific section.

According to an embodiment of the present disclosure, a vehicle speed detection method performed by a server processor of the vehicle speed detection apparatus may include obtaining CCTV captured images; selecting frames of the CCTV captured images at a first interval according to a predefined frame sampling rate; detecting a plurality of frames including at least one reference object having an end that matches with a designated part of a vehicle object among the frames selected at the first interval; detecting a travel time of the vehicle object by identifying intervals of the plurality of frames; and detecting speed information of the vehicle object by using pre-stored distance information between the at least one reference object and the travel time of the vehicle.

In the method, detecting a travel time may include detecting the travel time of the vehicle object based on a frame interval between a first frame including a first reference object having one end matching with the designated part of the vehicle object and a second frame including the first reference object having another end matching with the designated part of the vehicle object, and detecting speed information may include detecting the speed information of the vehicle object by using pre-stored length information of the first reference object and the travel time of the vehicle.

In the method, detecting a travel time may include: detecting the travel time of the vehicle object based on a frame interval between a first frame including a first reference object having one end matching with the designated part of the vehicle object and a second frame including a second reference object having one end matching with the designated part of the vehicle object, and detecting speed information may include: detecting the speed information of the vehicle object by using pre-stored distance information between the first reference object and the second reference object and the travel time of the vehicle.

In the method, detecting a plurality of frames may further include: adjusting the frame sampling rate in case of failing to detect the reference object having one end matching with the designated part of the vehicle object; selecting frames of the CCTV captured images at a second interval narrower than the first interval based on the adjusted frame sampling rate; and detecting the vehicle object and the at least one reference object for the frames selected at the second interval.

The method may further include: transmitting a control signal to a CCTV camera device providing the CCTV captured images to increase a captured speed by a designated speed in case of failing to detect the reference object having one end matching with the designated part of the vehicle object.

According to an embodiment of the present disclosure, a vehicle speed detection apparatus may include: a server communication circuit; and a server processor functionally connected to the server communication circuit and configured to: obtain a first CCTV captured image including a road and location information of the first CCTV captured image, detect at least one structure object to be used for speed detection of a vehicle driving on the road based on the first CCTV captured image, and collect map information based on the location information, match the at least one structure object with at least one structure included in the map information, obtain length information of the at least one structure from the map information, calculate distance information of the at least one structure object based on length information on the map information, and store the calculated distance information.

In the apparatus, the server processor may be configured to: detect a first structure object from the first CCTV captured image, match the first structure object with a first structure on the map information, obtain a distance value between a first point and a second point of the first structure from the map information, and calculate distance information of the first structure object by applying a scale of the map information to the distance value.

In the apparatus, the server processor may be configured to: obtain a second CCTV captured image including the vehicle driving on the road, in the second CCTV captured image, track from a frame where a first point of the first structure object and one point of the vehicle coincide to a frame where a second point of the first structure object and the point of the vehicle coincide, thereby calculating a travel time of the vehicle between the first and second points, and detect a speed of the vehicle based on the travel time and the distance information.

In the apparatus, the server processor may be configured to: detect the first structure object and the second structure object from the first CCTV captured image, match the first structure object and the second structure object with the first structure and the second structure on the map information, respectively, obtain a distance value between one point of the first structure and one point of the second structure from the map information, and calculate distance information between the first structure object and the second structure object by applying a scale of the map information to the distance value.

In the apparatus, the server processor may be configured to: obtain a second CCTV captured image including the vehicle driving on the road, in the second CCTV captured image, track from a first frame where one point of the first structure object and one point of the vehicle coincide to a second frame where one point of the second structure object and the point of the vehicle coincide, thereby calculating a travel time of the vehicle between the one point of the first structure object and the one point of the second structure object, and detect a speed of the vehicle based on the travel time and the distance information.

In the apparatus, the server processor may be configured to: detect the first structure object and the second structure object in the first CCTV captured image by using an edge detection method, and identify first and second structures having an arrangement matching with the first and second structure objects on the location information of the map information, thereby matching the first and second structure objects to the identified first and second structures.

In the apparatus, the server processor may be configured to: obtain a second CCTV captured image including the vehicle driving on the road, generate a control signal requesting a change in a CCTV capture direction in case of failing to a frame in which the at least one structure object detected in the second CCTV captured image matches with a specific part of the vehicle object, and provide the control signal to a mobile CCTV camera device providing the CCTV captured image.

According to an embodiment of the present disclosure, a vehicle speed detection method performed by a server processor of a vehicle speed detection apparatus using a mobile CCTV camera device may include: obtaining a first CCTV captured image including a road and location information of the first CCTV captured image; detecting at least one structure object to be used for speed detection of a vehicle driving on the road based on the first CCTV captured image, and collect map information based on the location information; matching the at least one structure object with at least one structure included in the map information; obtaining length information of the at least one structure from the map information; calculating distance information of the at least one structure object based on length information on the map information; and storing the calculated distance information.

In the method, matching the at least one structure object may include: detecting a first structure object from the first CCTV captured image; matching the first structure object with a first structure on the map information; obtaining a distance value between a first point and a second point of the first structure from the map information; and calculating distance information of the first structure object by applying a scale of the map information to the distance value.

The method may further include: obtaining a second CCTV captured image including the vehicle driving on the road; in the second CCTV captured image, tracking from a frame where a first point of the first structure object and one point of the vehicle coincide to a frame where a second point of the first structure object and the point of the vehicle coincide, thereby calculating a travel time of the vehicle between the first and second points; and detecting a speed of the vehicle based on the travel time and the distance information.

In the method, matching the at least one structure object may include: detecting the first structure object and the second structure object from the first CCTV captured image; matching the first structure object and the second structure object with the first structure and the second structure on the map information, respectively; obtaining a distance value between one point of the first structure and one point of the second structure from the map information; and calculating distance information between the first structure object and the second structure object by applying a scale of the map information to the distance value.

The method may further include: obtaining a second CCTV captured image including the vehicle driving on the road; in the second CCTV captured image, tracking from a first frame where one point of the first structure object and one point of the vehicle coincide to a second frame where one point of the second structure object and the point of the vehicle coincide, thereby calculating a travel time of the vehicle between the one point of the first structure object and the one point of the second structure object; and detecting a speed of the vehicle based on the travel time and the distance information.

In the method, matching the first structure object and the second structure object may include: identifying first and second structures having an arrangement matching with the first and second structure objects on the location information of the map information, thereby matching the first and second structure objects to the identified first and second structures.

The method may further include: obtaining a second CCTV captured image including the vehicle driving on the road; generating a control signal requesting a change in a CCTV capture direction in case of failing to a frame in which the at least one structure object detected in the second CCTV captured image matches with a specific part of the vehicle object; and providing the control signal to a mobile CCTV camera device providing the CCTV captured image.

### BRIEF DESCRIPTION OF DRAWINGS

FIG. 1 is a schematic diagram illustrating a speeding vehicle detection system according to the first embodiment of the present disclosure.

FIG. 2 is a block diagram illustrating the configuration of a speeding vehicle detection device according to the first embodiment of the present disclosure.

FIG. 3 is a flowchart illustrating a method for generating a detection model according to the first embodiment of the present disclosure.

FIG. 4 is an exemplary diagram illustrating learning data for generating the detection model shown in FIG. 3.

FIG. 5 is a flowchart illustrating a homography derivation method according to the first embodiment of the present disclosure.

FIG. 6 is a schematic diagram illustrating the homography derivation method shown in FIG. 5.

FIG. 7 is a flowchart illustrating a speeding vehicle detection method according to the first embodiment of the present disclosure.

FIGS. 8 to 10 are exemplary diagrams illustrating the speeding vehicle detection method shown in FIG. 7.

FIG. 11 is an exemplary diagram of a hardware system for implementing a speeding vehicle detection device according to an embodiment of the present disclosure.

FIG. 12 is a schematic diagram illustrating an example of a vehicle speed detection environment according to the second embodiment of the present disclosure.

FIG. 13 is a block diagram illustrating the configuration of a CCTV camera device according to the second embodiment of the present disclosure.

FIG. 14 is a block diagram illustrating the configuration of a monitoring device according to the second embodiment of the present disclosure.

FIG. 15 is a block diagram illustrating the configuration of a server processor in the monitoring device shown in FIG. 14.

FIG. 16 is a flowchart illustrating one example of a vehicle speed detection method using CCTV captured images according to the second embodiment of the present disclosure.

FIG. 17 is a flowchart illustrating another example of a vehicle speed detection method using CCTV captured images according to the second embodiment of the present disclosure.

FIG. 18 is a schematic diagram illustrating an example of a vehicle speed detection environment according to the third embodiment of the present disclosure.

FIG. 19 is a block diagram illustrating the configuration of a mobile CCTV camera device according to the third embodiment of the present disclosure.

FIG. 20 is a block diagram illustrating the configuration of a monitoring device according to the third embodiment of the present disclosure.

FIG. 21 is a block diagram illustrating the configuration of a server processor in the monitoring device shown in FIG. 20.

FIG. 22 is a flowchart illustrating a reference distance setting method based on a mobile CCTV camera device according to the third embodiment of the present disclosure.

FIG. 23 is a flowchart illustrating a vehicle speed detection method based on a mobile CCTV camera device according to the third embodiment of the present disclosure.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In the description and claims, the term “network” is defined as one or more data links that enable electronic data to be transmitted between computer systems and/or modules. When any information is transferred or provided to a computer system via a network or other (wired, wireless, or a combination thereof) communication connection, this connection can be understood as a computer-readable medium. The computer-readable instructions include, for example, instructions and data that cause a general purpose computer system or special purpose computer system to perform a particular function or group of functions. The computer-executable instructions may be binary, intermediate format instructions, such as, for example, an assembly language, or even source code.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

### First Embodiment

Hereinafter, the first embodiment of the present disclosure will be described with reference to FIGS. 1 to 11.

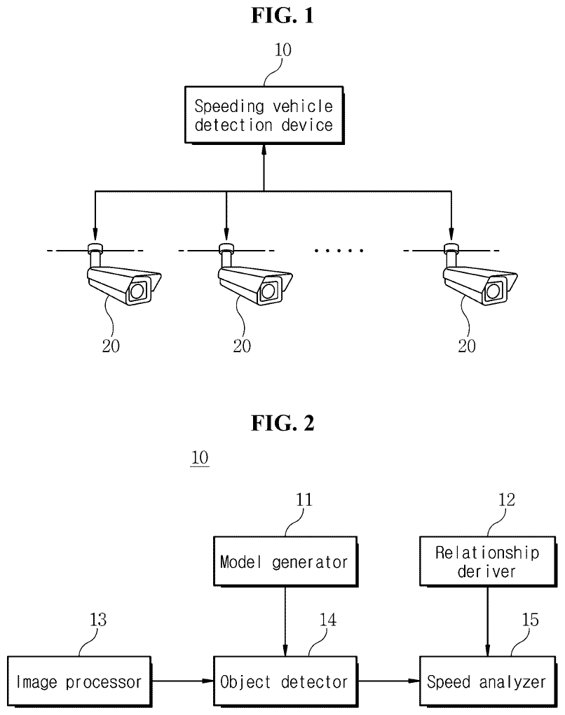

FIG. 1 is a schematic diagram illustrating a speeding vehicle detection system according to the first embodiment of the present disclosure, and FIG. 2 is a block diagram illustrating the configuration of a speeding vehicle detection device according to the first embodiment of the present disclosure.

First, referring to FIG. 1, the system according to the first embodiment of the present disclosure includes a speeding vehicle detection device 10 and a plurality of imaging devices 20.

The imaging device 20 is a device including a camera for obtaining a streaming video. For example, the imaging device 20 may be a device that is fixedly installed on one side of the road for speed monitoring. The imaging device 20 may include a camera for obtaining a streaming video, a transceiver for transmitting the video to the speeding vehicle detection device 10, and a microcontroller unit (MCU) for controlling the camera and transceiver.

The speeding vehicle detection device 10 receives a plurality of streaming videos from the plurality of imaging devices 20, analyzes the received streaming videos to detect vehicles, and determines whether the detected vehicles are speeding.

Referring to FIG. 2, the speeding vehicle detection device 10 includes a model generator 11, a relationship deriver 12, an image processor 13, an object detector 14, and a speed analyzer 15.

The model generator 11 is a component that generates a detection model (DM) through learning (e.g., deep learning or machine learning). The detection model is trained to detect a bounding box indicating an area occupied by a vehicle in an image. When the detection model is generated, the model generator 11 provides the detection model to the object detector 14.

The detection model includes a plurality of layers, and each of the plurality of layers performs a plurality of operations. In one layer, each result of the plurality of operations is weighted and transmitted to the next layer. This means that weights are applied to the operation results of the current layer and input to the operations of the next layer. In other words, the detection model performs a plurality of operations to which the weights of the plurality of layers are applied. The plurality of layers of the detection model include at least one of a fully-connected layer, a convolutional layer, a recurrent layer, a graph layer, and a pooling layer. The plurality of operations may include at least one of a convolution operation, a down sampling operation, an up sampling operation, a pooling operation, and an operation by an activation function. Here, the activation function may include a sigmoid, a hyperbolic tangent (tanh), an exponential linear unit (ELU), a rectified linear unit (ReLU), a leakly ReLU, a Maxout, a Minout, or a Softmax. In an example, the detection model may be R-CNN, R-FCN, FPN-FPCN, YOLO, SDD, RetinaNet, etc. When an image is input, the detection model performs a plurality of operations for applying weights of a plurality of layers to the input image and thereby detects a bounding box representing the area occupied by an object (i.e., a vehicle).

The relationship deriver 12 is a component that derives a homography according to the first embodiment. Using an image (IMG) which is training data and a ground map (GM) corresponding to the image, the relationship deriver 12 derives a homography that converts one coordinate in the image into the corresponding coordinate in the ground map. Here, the image may be one frame of a streaming video. The image contains a road captured by the camera of the imaging device 20 and is composed of a pixel coordinate system. The ground map GM expresses the road indicated by the image and has a two-dimensional coordinate system in accordance with the metric system corresponding to the actual size. The relationship deriver 12 provides the derived homography to the speed analyzer 15.

The image processor 13 receives a streaming video of a road from the imaging device 20, extracts a plurality of frames from the received streaming video, and sequentially provides them to the object detector 14.

The object detector 14 detects a vehicle through the bounding box (BB) in the plurality of frames of the streaming video by using the detection model, and provides the plurality of frames in which a vehicle is detected through the bounding box to the speed analyzer 15.

Then, the speed analyzer 15 can calculate the speed of the detected vehicle by analyzing the movement of the bounding box in the plurality of frames in which the vehicle is detected. At this time, the speed analyzer 15 calculates a travel distance of the vehicle by using a moving distance of the bounding box from the first frame to the last frame among the plurality of frames in which the vehicle is detected. Then, the speed analyzer 15 calculates a distance between the coordinates of the converted ground map as the travel distance of the vehicle. At this time, the travel distance can be calculated according to Equation 3 to be described later. In addition, the speed analyzer 15 calculates a travel time of the vehicle by applying the frame rate of the streaming video to the number of the plurality of frames in which the vehicle is detected. Then, the speed analyzer 15 calculates the speed of the vehicle through the calculated travel distance and travel time, and determines whether the vehicle is speeding based on the calculated speed. If speeding is determined, the speed analyzer 15 may provide information proving speeding to a server of a relevant organization.

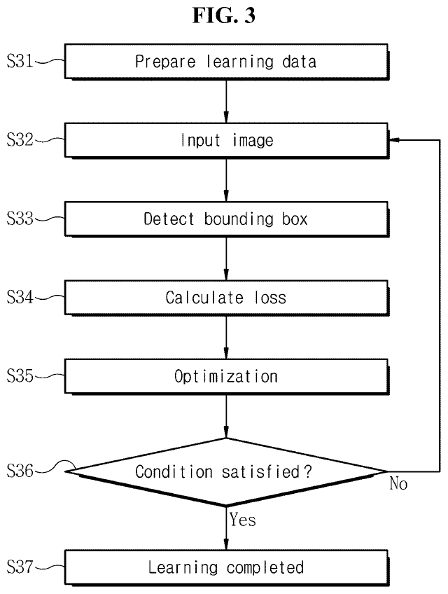

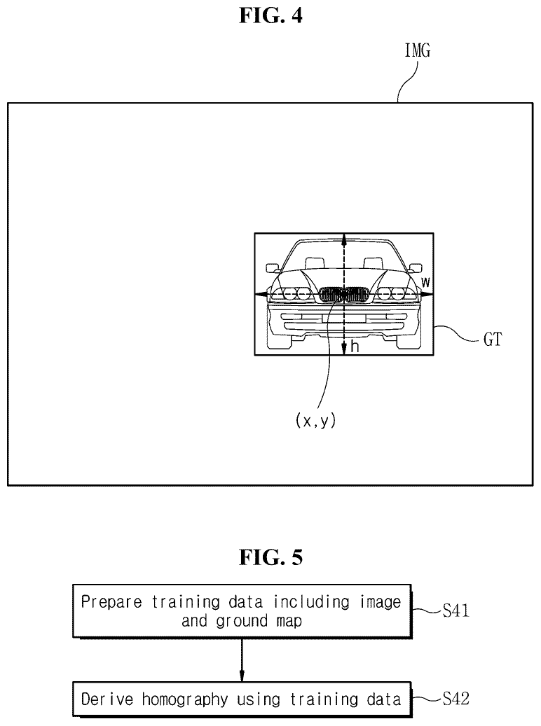

Next, a method for generating the detection model (DM) will be described. FIG. 3 is a flowchart illustrating a method for generating a detection model according to the first embodiment of the present disclosure. FIG. 4 is an exemplary diagram illustrating learning data for generating the detection model shown in FIG. 3.

Referring to FIG. 3, in step S31, the model generator 11 prepares learning data for training the detection model. The learning data includes an image and a label corresponding to the image. An example of such learning data is illustrated in FIG. 4. Here, an image (IMG) may be one frame of a streaming video. In addition, the image (IMG) is an image obtained by photographing a vehicle. The label is a bounding box indicating an area occupied by the vehicle in the image. The bounding box used as the label is referred to as a ground-truth box (GT) in order to distinguish it from the above-described bounding box detected by the detection model. The ground-truth box (GT) is defined through center coordinates (x, y), width (w), and height (h).

When the learning data is prepared, in step S32, the model generator 11 inputs the image into the detection model whose learning is uncompleted.

Then, in step S33, the detection model performs a plurality of operations for applying untrained inter-layer weights to the input image, thereby detecting a bounding box (BB) that is an area occupied by the vehicle within the image.

Thus, in step S34, the model generator 11 can calculate a loss indicating a difference between the detected bounding box (BB) and the ground-truth box (GT) through a loss function.

Then, in step S35, the model generator 11 performs optimization to modify the weight of the detection model so that the loss derived through the loss function is minimized.

The above-described steps S32 to S35 are repeatedly performed using different multiple learning data, and the weights of the detection model are repeatedly updated according to this repetition. Also, this repetition is performed until the loss converges and becomes below a predetermined target value.

Therefore, in step S36, the model generator 11 checks whether the learning completion condition is satisfied. For example, the model generator 11 determines whether the loss calculated in step S34 converges and is below the predetermined target value.

If the learning completion condition is satisfied, the model generator 11 completes learning for the detection model (DM) in step S37.

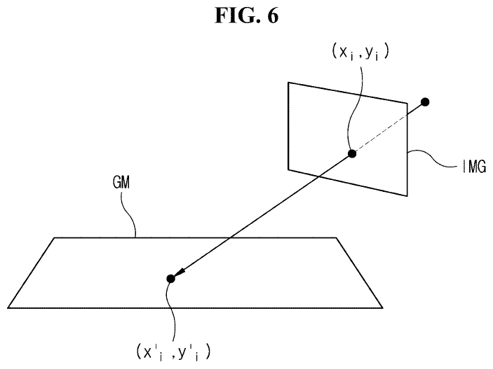

Next, a method for deriving homography will be described. FIG. 5 is a flowchart illustrating a homography derivation method according to the first embodiment of the present disclosure. FIG. 6 is a schematic diagram illustrating the homography derivation method shown in FIG. 5.

Referring to FIG. 5, in step S41, the relationship deriver 12 prepares training data. The training data includes an image (IMG) and a ground map (GM) corresponding to the image (IMG).

Referring to FIG. 6, the image (IMG) may be any one frame of a streaming video. The image (IMG) contains a road captured by the camera of the imaging device 20 and is composed of a pixel coordinate system. The ground map (GM) expresses the road indicated by the image (IMG) and has a two-dimensional coordinate system based on a metric system corresponding to the actual size.

Next, in step S42, using the image (IMG) and the ground map (GM) of the training data, the relationship deriver 12 derives a homography that converts one coordinates (xᵢ, yᵢ) of the image into corresponding coordinates (xᵢ′, yᵢ′) of the ground map.

When hᵢⱼ (i≤1, j≤3) denotes a matrix representing the homography, and Equation 1 below is satisfied, the relationship deriver 12 can derive a matrix that minimizes Equation 2 below as the homography.

$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ] \qquad [ Equation 1 ]$$

$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2} \qquad [ Equation 2 ]$$

Here, (xᵢ, yᵢ) represents the coordinates of the image (IMG), and (xᵢ′, yᵢ′) represents the coordinates of the ground map (GM).

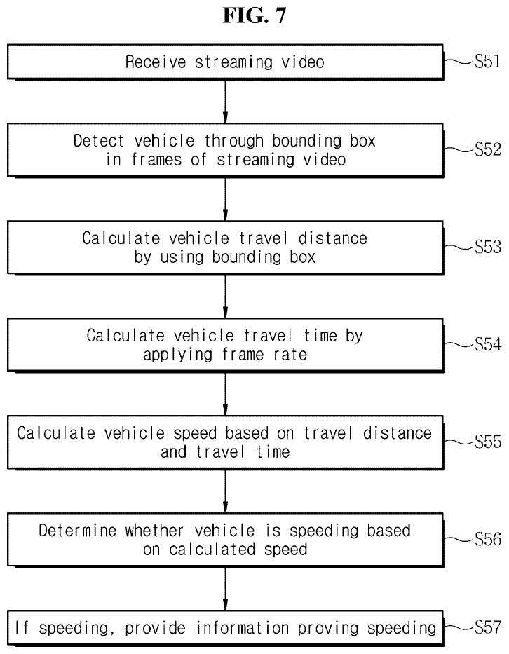

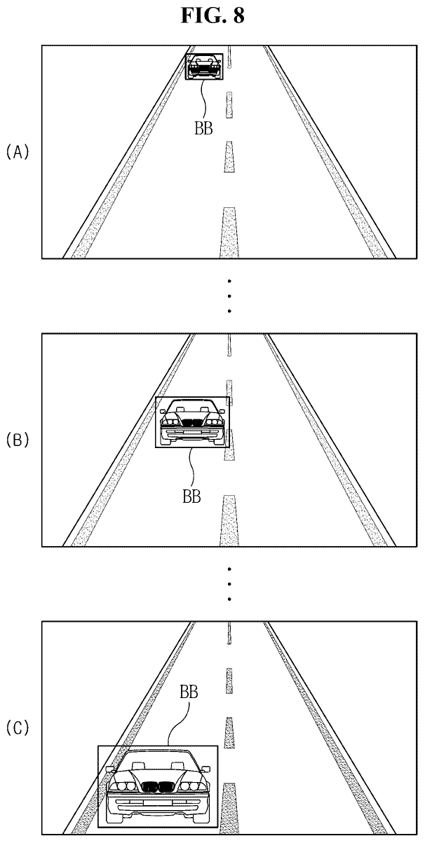

Next, a method for detecting a speeding vehicle by using the detection model and the homography, generated through learning as described above, will be described. FIG. 7 is a flowchart illustrating a speeding vehicle detection method according to the first embodiment of the present disclosure. FIGS. 8 to 10 are exemplary diagrams illustrating the speeding vehicle detection method shown in FIG. 7.

Referring to FIG. 7, in step S51, the image processor 13 receives a streaming video of a road from the imaging device 20. The imaging device 20 extracts a plurality of frames from the received streaming video and sequentially provides them to the object detector 14.

Then, in step S52, the object detector 14 detects a vehicle through a bounding box (BB) in the plurality of frames of the streaming video by using a detection model. For example, (A), (B), and (C) of FIG. 8 show the plurality of frames of the streaming video. As shown, a vehicle can be detected through the bounding box (BB) in each frame.

The object detector 14 provides the plurality of frames in which a vehicle is detected through the bounding box (BB) to the speed analyzer 15. Then, the speed analyzer 15 can calculate the speed of the detected vehicle by analyzing the movement of the bounding box in the plurality of frames in which the vehicle is detected among the plurality of frames.

To this end, in step S53, the speed analyzer 15 calculates a travel distance of the vehicle by using a movement distance of the bounding box from the first frame to the last frame among the plurality of frames in which the vehicle is detected. This step S53 will be described in more detail as follows.

First, the speed analyzer 15 applies the previously derived homography to convert the center coordinates of the bounding box in each of the first and last frames among the plurality of frames in which the vehicle is detected into coordinates in the ground map.

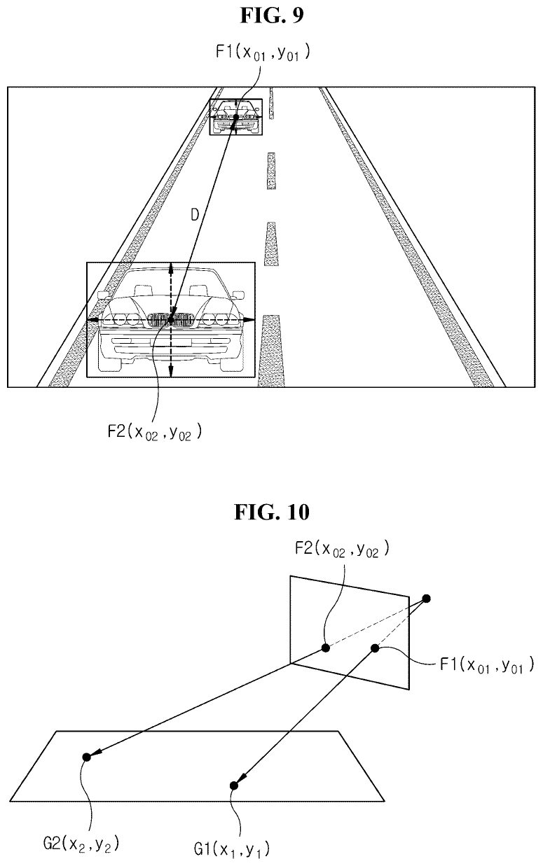

For example, FIG. 9 shows the center coordinates F1(x₀₁,y₀₁) of the bounding box in the first frame and the center coordinates F2(x₀₂,y₀₂) of the bounding box in the last frame among the plurality of frames in which the vehicle is detected.

As shown in FIG. 10, the speed analyzer 15 applies the homography as derived in FIG. 5 to convert the center coordinates F1(x₀₁,y₀₁) of the bounding box in the first frame and the center coordinates F2(x₀₂,y₀₂) of the bounding box in the last frame among the plurality of frames in which the vehicle is detected into coordinates G1(x₁,y₁) and G2(x₂,y₂) in the ground map, respectively.

Then, the speed analyzer 15 calculates a distance between the converted coordinates in the ground map as a travel distance of the vehicle. At this time, the travel distance can be calculated according to Equation 3 below.

$$D = \sqrt{{( {x}_{2} - {x}_{1} )}^{2} - {( {y}_{2} - {y}_{1} )}^{2}} \qquad [ Equation 3 ]$$

Here, D represents the travel distance of the vehicle. In addition, x₁ and y₁ are ground coordinates converted from the center coordinates of the bounding box in the first frame among the plurality of frames in which the vehicle is detected, and x₂ and y₂ are ground coordinates converted from the center coordinates of the bounding box in the last frame among the plurality of frames in which the vehicle is detected.

Next, in step S54, the speed analyzer 15 calculates a travel time of the vehicle by applying the frame rate of the streaming video to the number of the plurality of frames in which the vehicle is detected. For example, if the frame rate of the streaming video is 18 fps and the number of frames in which the vehicle is detected is 36, the travel time becomes 2 seconds.

Next, in step S55, the speed analyzer 15 calculates the speed of the vehicle based on the calculated travel distance and travel time.

Then, in step S56, the speed analyzer 15 determines whether the vehicle is speeding, based on the calculated speed.

Next, if speeding is determined, the speed analyzer 15 provides information proving speeding to the server of the relevant organization in step S57.

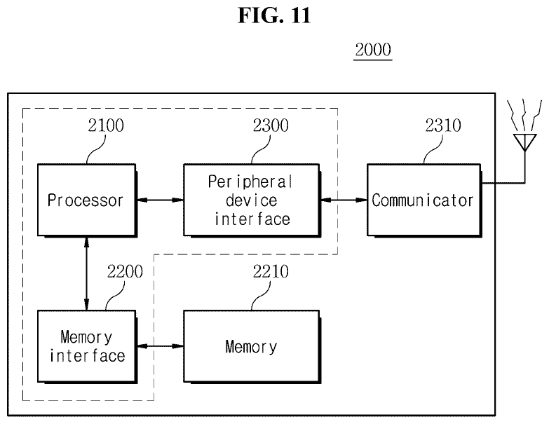

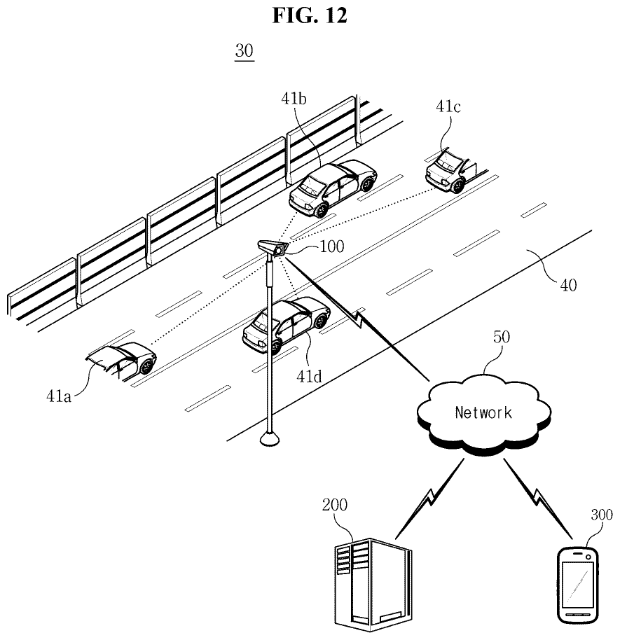

FIG. 11 is an exemplary diagram of a hardware system for implementing a speeding vehicle detection device according to an embodiment of the present disclosure.

As shown in FIG. 11, the hardware system 2000 may include a processor 2100, a memory interface 2200, and a peripheral device interface 2300.

These respective elements in the hardware system 2000 may be individual components or be integrated into one or more integrated circuits and may be connected by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

In the memory 2210, components such as the model generator 11, the relationship deriver 12, the image processor 13, the object detector 14, and the speed analyzer 15 described above in FIG. 2 may be stored in the form of software modules, and the operating system (OS) may be further stored. These components may be loaded into and executed by the processor 2100.

In addition, the above-mentioned components may be implemented in the form of a software module or hardware module executed by the processor 2100, or may also be implemented in the form of a combination of a software module and a hardware module. As such, the software module, the hardware module, or the combination thereof executed by the processor may be implemented as an actual hardware system (e.g., a computer system).

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices. The peripheral devices are to provide different functions to the hardware system 2000, and may include a communicator 2310 for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, WLAN (Wireless LAN), DLNA (Digital Living Network Alliance), Wibro (Wireless Broadband), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, LTE (Long Term Evolution), LTE-A (Long Term Evolution-Advanced), 5G communication system, WMBS (Wireless Mobile Broadband Service), Bluetooth, RFID (Radio Frequency Identification), IrDA (Infrared Data Association), UWB (Ultra-Wideband), ZigBee, NFC (Near Field Communication), USC (Ultra Sound Communication), VLC (Visible Light Communication), Wi-Fi, Wi-Fi Direct, and the like. In addition, as wired communication networks, wired LAN (Local Area Network), wired WAN (Wide Area Network), PLC (Power Line Communication), USB communication, Ethernet, serial communication, optical/coaxial cables, etc. may be included. This is not a limitation, and any protocol capable of providing a communication environment with other devices may be included.

In the hardware system 2000 according to the present disclosure, each components stored in the memory 2210 in the form of a software module performs an interface with the communicator 2310 via the memory interface 2200 and the peripheral device interface 2300 in the form of a command executed by the processor 2100.

### Second Embodiment

Hereinafter, the second embodiment of the present disclosure will be described with reference to FIGS. 12 to 17.

FIG. 12 is a schematic diagram illustrating an example of a vehicle speed detection environment according to the second embodiment of the present disclosure.

Referring to FIG. 12, the vehicle speed detection environment 30 corresponds to a case where the speed of a vehicle is detected based on a CCTV captured image. The vehicle speed detection environment 30 may include a road 40, vehicles 41a, 41b, 41c, and 41d driving on the road 40, a CCTV camera device 100 that obtains CCTV captured images of the vehicles 41a, 41b, 41c, and 41d, a network 50, a monitoring device 200, and a user terminal 300. Depending on cases, the network 50 and the user terminal 300 may be omitted from the vehicle speed detection environment 30.

In the vehicle speed detection environment 30 described below, the CCTV camera device 100 records a CCTV video composed of a plurality of frames, i.e., CCTV captured images, and transmits the recorded CCTV video to the monitoring device 200 via the network 50, and the monitoring device 200 detects at least one vehicle object and at least one reference object from the CCTV video and detects a vehicle speed through analysis of the detected vehicle object and reference object. However, the present disclosure is not limited thereto. Alternatively, the CCTV camera device 100 may be an internal component of the monitoring device 200, or the monitoring device 200 may be included as an internal component of the CCTV camera device 100. In such cases, without requiring the network 50, the CCTV camera device 100 and the monitoring device 200 may be provided in the form of a single electronic device.

The road 40 may include an area where a video is recorded by the CCTV camera device 100. The plurality of vehicles 41a, 41b, 41c, and 41d may drive on the road 40. A plurality of lanes including a stop line or a center line may be arranged (or printed) on the road 40. On the road 40, bumps may be arranged to control the driving speeds of the plurality of vehicles 41a, 41b, 41c, and 41d or information guiding a speed limit may be arranged (or printed). The road 40 may have various structural or printed objects that may be used as reference objects corresponding to start and end positions when detecting vehicle speeds in the CCTV captured images of the CCTV camera device 100. The structural objects may include, for example, guide rails or guard structures installed to prevent the vehicles 41a, 41b, 41c, and 41d from leaving the road 40. The printed objects may include, for example, lanes in the form of dotted lines printed on the road 40. A safe speed may be set by an administrator of the road 40.

The CCTV camera device 100 may be positioned so as to record a CCTV video for at least a portion of the road 40. For example, the CCTV camera device 100 may be positioned at the edge of the road 40 or around the road 40 so as to record a video for the road 40 at a certain angle, or may be mounted on a pole-like structure at a certain distance upward from the ground of the road 40. The CCTV camera device 100 may record a CCTV video for the road 40 under the control of the monitoring device 200 and transmit the recoded CCTV video to the monitoring device 200. In the second embodiment, the CCTV camera device 100 is described as including one CCTV camera. However, in an alternative embodiment, the CCTV camera device 100 may include a plurality of CCTV cameras. In this case, the plurality of CCTV cameras may be arranged to acquire CCTV videos for the corresponding lanes or corresponding areas, respectively. The CCTV camera device 100 may adjust the number of frames per second of the CCTV video according to the settings or in response to the request of the monitoring device 200. For example, the CCTV camera device 100 may record the CCTV video based on a relatively low number of frames per second or a relatively high number of frames per second.

The monitoring device 200 (or referred to as a server device, a vehicle speed detection device, a speeding vehicle detection device, etc.) may receive CCTV captured images of the road 40 from the CCTV camera device 100 and perform vehicle speed detection for at least one vehicle based on the received CCTV captured images. In this regard, the monitoring device 200 may select reference objects corresponding to a start position and an end position to be used for vehicle speed detection from a CCTV captured image in which there is no vehicle, and may collect and store distance information of the selected reference objects in response to an external input. The monitoring device 200 may then acquire CCTV captured images containing a vehicle object, detect a travel time of the vehicle object by tracking the movement of the vehicle object from the start position to the end position in the acquired CCTV captured images, and calculate a speed of the vehicle object using the pre-stored distance information. In an example, the monitoring device 200 may detect the reference objects together during the process of detecting the vehicle object in the CCTV captured images. The reference objects may include, for example, a start reference point object corresponding to the start position and an end reference point object corresponding to the end position. The start reference point object may refer to an object corresponding to a point where, after a certain vehicle 41a, 41b, 41c, or 41d enters the view of the CCTV camera device 100, distance calculation of the vehicle begins for speed detection of the vehicle. The end reference point object may refer to an object corresponding to a point where distance calculation of the vehicle ends for speed detection of the vehicle immediately before the vehicle leaves the view of the CCTV camera device 100. The start reference point object and the end reference point object are within the view of the CCTV camera device 100 and may include reference point objects for which distance information is provided in advance. The monitoring device 200 may include an algorithm used to remove a background, etc., and detect the vehicle(s) 41a, 41b, 41c, and/or 41d and the reference objects in the CCTV captured images provided by the CCTV camera device 100.

In another example, the monitoring device 200 may select frames at a first interval according to a predetermined frame sampling rate in the CCTV recorded video provided by the CCTV camera device 100, and detect the vehicle object and the reference objects in the selected frames. Then, the monitoring device 200 may calculate the travel time of the vehicle object by using frames in which a specific part of the vehicle object and a specific part of each reference object match. Then, based on the distance between the reference objects and the travel time of the vehicle object, the monitoring device 200 may calculate the speed of the vehicle object.

When the speed of the detected vehicle object 41a, 41b, 41c, or 41d is higher than a predefined reference value, the monitoring device 200 may recognize a vehicle number of the detected vehicle object, set a speed violation marking on the recognized vehicle number, and provide related information to a designated server device (e.g., a computing device operated by a government office). In addition, when the degree of speed violation is within a predefined guide range, the monitoring device 200 may obtain a user telephone number registered together with the vehicle number, and transmit a guide message related to the speed violation to the corresponding user through the obtained user telephone number.

If there is a vehicle that violates the speed limit, the monitoring device 200 may obtain information about the vehicle (e.g., at least one of a vehicle model, vehicle license plate information, and vehicle color) and issue a warning about the violation of the speed limit based on the obtained vehicle information. In an example, the vehicle speed detection environment 30 may further include an audio device capable of broadcasting a warning at a level that can be heard by drivers of the vehicles 41a, 41b, 41c, and 41d driving on the road 40. Additionally or alternatively, the vehicle speed detection environment 30 may further include a display device that is installed at a position that can be seen by drivers of the vehicles 41a, 41b, 41c, and 41d driving on the road 40 and can display warning information. The monitoring device 200 may form a communication channel with the audio device and/or the display device and provide warning information to the audio device and/or the display device. Additionally or alternatively, the monitoring device 200 may transmit a broadcast message notifying of a speed violation by using a base station located in the area where a vehicle violating the speed limit is driving.

The user terminal 300 may be a terminal of an administrator managing the road 40 (e.g., a terminal carried by a member of a road patrol team). The user terminal 300 may receive information on a vehicle violating the speed limit from the monitoring device 200. When receiving such information on a vehicle violating the speed limit, the user terminal 300 may output the received information along with an alarm on a terminal display. Additionally or alternatively, the user terminal 300 may be a portable terminal carried by a driver and/or a passenger of the vehicle 41a, 41b, 41c, or 41d driving on the road 40. The user terminal 300 may receive a warning message regarding a speed limit violation from a base station adjacent to the road 40 (or having a communication coverage capable of transmitting the message to a specific area of the road 40. When receiving the warning message, the user terminal 300 may output the received warning message on a terminal display or output it on a display device of a vehicle connected to the user terminal 300 through a communication channel. In this regard, the user terminal 300 may include a terminal communication circuit capable of communicating with a network 50, a terminal processor that controls the monitoring device 200 to connect to the monitoring device 200 through the network 50 and to receive and output a specific message (or warning information) provided by the monitoring device 200, a terminal display capable of outputting the received information, and a terminal memory for storing data related to the above-described operation.

The network 50 may support the formation of a communication channel among the CCTV camera device 100, the monitoring device 200, and the user terminal 300. The network 50 may include, for example, a communication element that supports a wired connection or a wireless connection between at least two of the CCTV camera device 100, the monitoring device 200, and the user terminal 300. In an example, when there are a plurality of CCTV cameras included in the CCTV camera device 100, the network 50 may connect the plurality of CCTV cameras by wire. In addition, the network 50 may wirelessly connect between the CCTV camera device 100 and the monitoring device 200 or between the monitoring device 200 and the user terminal 300. In relation to the wireless connection, the network 50 may include at least one base station and a base station controller. The network 50 is not limited to a specific communication scheme (or communication generation) and may include communication equipment that supports at least one of various communication schemes for signal flows among the CCTV camera device 100, the monitoring device 200, and the user terminal 300.

In the above-described environment 30 that supports vehicle speed detection based on the CCTV camera device 100 according to the second embodiment of the disclosure, it is possible to set at least a portion of a section between the positions of a start reference point object and an end reference point object related to vehicle speed detection among lanes of a video captured by a fixed CCTV, and to store the distance of the section in advance. Also, in the vehicle speed detection environment 30, it is possible to track each of the vehicles 41a, 41b, 41c, and 41d through a tracking model such as DeepSORT, measure the time it takes to reach from the start reference point object to the end reference point object, and then calculates the speed for each vehicle 41a, 41b, 41c, or 41d through the stored distance and the measured time.

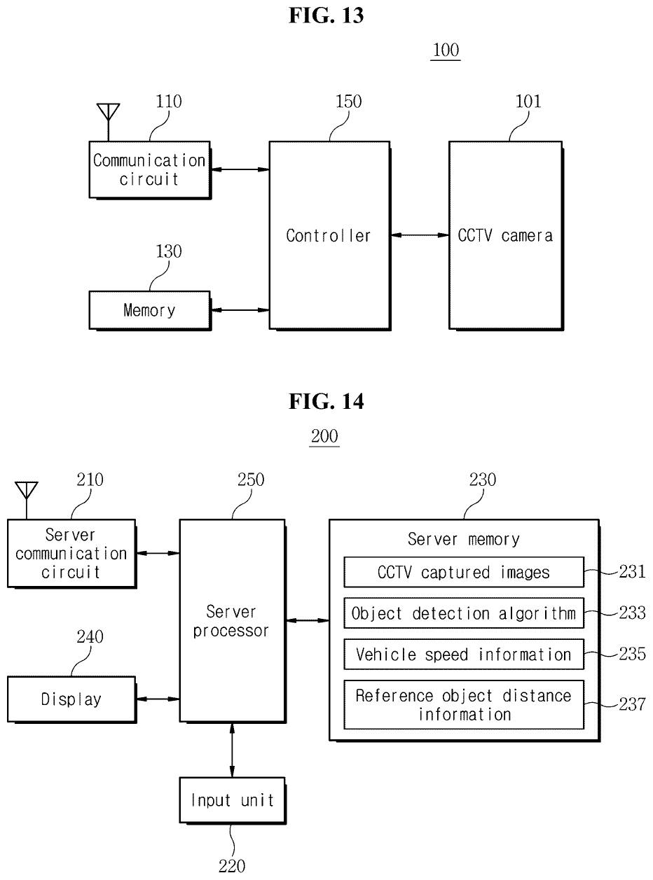

FIG. 13 is a block diagram illustrating the configuration of a CCTV camera device according to the second embodiment of the present disclosure.

Referring to FIG. 13, the CCTV camera device 100 according to the second embodiment may include a CCTV camera 101, a communication circuit 110, a memory 130, and a controller 150.

The CCTV camera 101 is placed at a specific location on the road 40 and can capture still images or video of vehicles 41a, 41b, 41c, and 41d driving on the road 40. When the road 40 includes multiple lanes, the CCTV camera 101 may be placed so as to capture each lane. Alternatively, the CCTV camera 101 may be placed so as to capture such multiple lanes at once. The CCTV camera 101 collects CCTV captured images (i.e., a CCTV captured video) for the road 40 under the control of the controller 150, and temporarily stores the collected CCTV captured images in the memory 130 or provides the collected CCTV captured images to the monitoring device 200 under the control of the controller 150. In the shooting environment of the CCTV camera 101, there may be a plurality of reference objects to be used for detecting the speed of the vehicle. For example, the CCTV captured images, i.e., images captured by the CCTV camera 101, may include a plurality of line segments (e.g., line segments of a dotted lane). Or, the CCTV captured images may include structures arranged at pre-recorded intervals. Under the control of the controller 150, the CCTV camera 101 may collect the CCTV captured images of a first frame rate or a second frame rate greater (or smaller) than the first frame rate. Therefore, the CCTV camera 101 may collect the CCTV captured images including a first number of frames per second or the CCTV captured images including a second number of frames per second.

The communication circuit 110 may include at least one communication module for establishing a communication channel of the CCTV camera device 100. For example, the communication circuit 110 may include a first communication module (or a first communication circuit) that may form a communication channel between the controller 150 and the CCTV camera 101, and a second communication module (or a second communication circuit) for a communication connection with the network 50. For example, the first communication module may include a wired communication module, and the second communication module may include a wireless communication module. The first communication module may transmit a control signal of the controller 150 to the CCTV camera 101 and receive CCTV captured images from the CCTV camera 101. The second communication module may form a communication channel with the monitoring device 200 and transmit the CCTV captured images received from the CCTV camera 101 to the monitoring device 200 according to predefined schedule information or in response to the control of the controller 150. Additionally, the second communication module may receive a control signal related to controlling the CCTV camera 101 from the monitoring device 200.

The memory 130 may store data or programs related to the operation of the CCTV camera device 100. For example, the memory 130 may receive CCTV captured images from the CCTV camera 101 at regular intervals or in real time and store them temporarily or semi-permanently.

The controller 150 can perform transmission and processing of signals related to the control of the CCTV camera device 100 and storage or transmission of the processing results. In an example, the controller 150 may generate a control signal for turn-on or turn-off control of the CCTV camera 101 and transmit the generated control signal to the CCTV camera 101. In addition, the controller 150 may transmit a control signal to the CCTV camera 101 to request transmission of CCTV captured images. Also, the controller 150 may receive the CCTV captured images from the CCTV camera 101 and deliver them to the monitoring device 200. The CCTV captured images may include a predefined number of frames per second. For example, the CCTV captured images may include 15 to 30 frames per second. The number of frames may vary depending on the performance of the CCTV camera 101. Additionally or alternatively, the controller 150 may adjust the frame rate of the CCTV camera 101 according to preset conditions (e.g., region or time) or under the control of the monitoring device 200. For example, the controller 150 may increase the frame rate per second of the CCTV camera 101 when the number of vehicles 41a, 41b, 41c, and 41d on the road 40 is less than a predefined first criterion and thus the vehicles are likely to speed, and may reduce the frame rate per second of the CCTV camera 101 when the number of vehicles 41a, 41b, 41c, and 41d on the road 40 is more than a predefined second criterion and thus the vehicles are unlikely to speed. Here, the vehicle count check may be performed by the CCTV camera device 100 or supported by the monitoring device 200. Additionally or alternatively, the controller 150 may increase the number of frames per second of the CCTV camera 101 during times when speeding vehicles are frequent, and may decrease the number of frames per second of the CCTV camera 101 during times when speeding vehicles are rare. Depending on at least one of the time zone, location, and request, the controller 150 may provide the CCTV captured images of different frames per second to the monitoring device 200.

FIG. 14 is a block diagram illustrating the configuration of a monitoring device according to the second embodiment of the present disclosure.

In FIGS. 12 to 14, the monitoring device 200 is illustrated as an element separate from the CCTV camera device 100, but the present disclosure is not limited thereto. For example, the monitoring device 200 may be integrated with the CCTV camera device 100. In this case, the CCTV camera device 100 described above may include the configuration of the monitoring device 200 to be described below and may perform a vehicle speed detection function based on that configuration. In the description of the monitoring device 200 with reference to FIG. 14, it is assumed that the monitoring device 200 receives the CCTV captured images (i.e., video) from the CCTV camera device 100 through the network 50.

Referring to FIG. 14, the monitoring device 200 (also referred to as a server device, a vehicle speed detection device, or a speeding vehicle detection device) may include a server communication circuit 210, an input unit 220, a server memory 230, a display 240, and a server processor 250.

The server communication circuit 210 may support the formation of a communication channel of the monitoring device 200. In an example, the server communication circuit 210 may include a first communication circuit capable of forming a communication channel with the CCTV camera device 100 through a network 50 and a second communication circuit capable of forming a communication channel with a user terminal 300 through the network 50. In the case where the server communication circuit 210 forms a communication channel with the CCTV camera device 100 and the user terminal 300 through the same type of communication scheme, the server communication circuit 210 may be configured as a single communication circuit. In an example, the server communication circuit 210 may receive at least one CCTV captured image from the CCTV camera device 100 in real time, at regular intervals, or upon request from the server processor 250. Meanwhile, if the CCTV camera device 100 is designed to detect the speed of a vehicle, the server communication circuit 210 may receive vehicle speed information and vehicle identification information (e.g., vehicle license plate information) about the vehicle 41a, 41b, 41c, or 41d that has violated the speed limit from the CCTV camera device 100.

The input unit 220 may include components that support administrator's inputs related to the operation of the monitoring device 200. For example, the input unit 220 may include at least one of various input devices such as a keyboard, a keypad, a mouse, a touchscreen, a touchpad, a touch key, a voice input device, a gesture input device, a joystick, and a wheel device. The input unit 220 may generate, in response to administrator's manipulation, at least one input signal from among an input signal requesting a communication connection with the CCTV camera device 100, an input signal requesting the CCTV camera device 100 to transmit CCTV captured images (this may be omitted if the CCTV camera device 100 is set to automatically transmit the CCTV captured images), an input signal requesting vehicle speed detection from the at least one received CCTV captured image, and an input signal indicating a warning when a vehicle that violates the speed limit exists. Then, the input unit 220 may transmit the generated input signal to the server processor 250. At least one of the above-described input signals may be omitted.

The server memory 230 may store at least one of data and programs related to the operation of the monitoring device 200. For example, the server memory 230 may include (or store) at least one of CCTV captured images 231, an object detection algorithm 233, vehicle speed information 235, and reference object distance information 237.

The CCTV captured images 231 may include CCTV captured images having the same or different frames per second, received from the CCTV camera device 100. For example, the CCTV captured images 231 may include at least one CCTV captured images provided by the CCTV camera 101 in real time, at regular intervals, or upon request with respect to the road 40. The CCTV captured images 231 may include images containing at least one vehicle 41a, 41b, 41c, and/or 41d and a plurality of reference objects.

The object detection algorithm 233 may include an algorithm or program capable of recognizing and detecting, from each of the CCTV captured images 231, the at least one vehicle 41a, 41b, 41c, and/or 41d and the plurality of reference objects located around the vehicle(s) 41a, 41b, 41c, and/or 41d.

The vehicle speed information 235 may include vehicle speed information calculated based on the at least one vehicle 41a, 41b, 41c, and/or 41d and the reference objects detected by the object detection algorithm 233.

The reference object distance information 237 may include distance information of reference objects used to detect the vehicle speed information 235. For example, the reference object distance information 237 may include length information of a specific reference object detected from the CCTV captured image and/or interval information between the reference objects detected from the CCTV captured image. The reference object distance information 237 corresponding to the length information of the reference object or the interval information between the reference objects may be designated by an administrator input or may be received from an external server device that provides such information. For example, the length of a lane in the form of a dotted line printed on the road 40 may vary depending on the characteristics (e.g., location) of the road 40, and such information may be provided by a server device of a public institution (or a specific institution) that prints the lane. Also, the intervals of structures (e.g., median strip pillars) installed on the road 40 may be provided by a server device operated by a construction company (or a related institution) that installed the corresponding structure.

The display 240 may output at least one screen related to the operation of the monitoring device 200. For example, the display 240 may output at least one screen from among a screen indicating a connection status with the CCTV camera device 100, a screen displaying the CCTV captured images 231 received from the CCTV camera device 100 in real time, at a certain interval, or upon request, a screen marking the at least one vehicle 41a, 41b, 41c, and/or 41d and the reference objects detected from the CCTV captured images 231, a screen marking a vehicle that has violated the speed limit, a screen displaying information on the vehicle that has violated the speed limit, and a screen notifying that a warning is being issued to the vehicle that has violated the speed limit. At least one of the above-described screens may be omitted depending on the administrator settings.

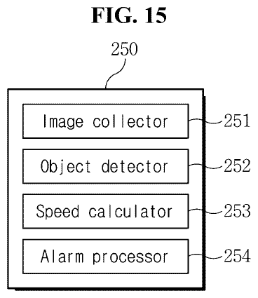

The server processor 250 may perform operations of receiving, transmitting, and processing signals related to the operation of the monitoring device 200, and storing or transmitting the results of processing. For example, the server processor 250 may receive the CCTV captured images 231 from the CCTV camera device 100 according to preset scheduling information or according to an administrator input, detect at least one vehicle object and a specific reference object or a plurality of reference objects from the received CCTV captured images 231 using the object detection algorithm 233, and perform vehicle speed detection based on the detected information. If a plurality of vehicle objects are contained in the CCTV captured images, the server processor 250 may perform vehicle speed detection for each of the plurality of vehicle objects. In this regard, the server processor 250 may include a configuration as illustrated in FIG. 15.

FIG. 15 is a block diagram illustrating the configuration of a server processor in the monitoring device shown in FIG. 14.

Referring to FIG. 15, the server processor 250 may include an image collector 251, an object detector 252, a speed calculator 253, and an alarm processor 254.

The image collector 251 can generate a control signal related to the control of the CCTV camera device 100 and transmit the generated control signal to the CCTV camera device 100 through the network 50. In an example, the image collector 251 may generate a control signal related to the turn-on or turn-off control of the CCTV camera 101 according to preset scheduling information or an administrator input signal. The image collector 251 may provide a status related to the control of the CCTV camera device 100 to the display 240 of the monitoring device 200. In another example, the image collector 251 may control to provide CCTV captured images from the CCTV camera 101 and transmit the received CCTV captured image to the object detector 252. In an example, the image collector 251 may generate a control signal for adjusting a capture speed (or the number of captured frames per second) of the CCTV camera 101 according to at least one of time, location, and request, transmit the generated control signal to the CCTV camera device 100, and collect the CCTV captured images having the corresponding number of captured frames per second.

In an example, the image collector 251 may collect information on time zones when there are many speeding vehicles that have violated the speed limit statistically. Also, the image collector 251 may collect information on time zones when there are many speeding vehicles that have been entered by an administrator or collected from a statistics server. The image collector 251 may provide the time zone information to the CCTV camera device 100 and request the CCTV camera device 100 to transmit CCTV captured images captured based on a higher number of frames per second during the corresponding time zones. Alternatively, when the corresponding time zone arrives, the image collector 251 may request the CCTV camera device 100 to transmit a higher number of frames per second than the previous CCTV captured images and obtain the corresponding CCTV captured images.

In an example, the image collector 251 may collect location information on a location with many speeding vehicles based on collected statistical information or by administrator input. The image collector 251 may identify the location, identify the CCTV camera device 100 installed at the identified location, and then request the CCTV camera device 100 to provide CCTV captured images with a greater number of frames per second than CCTV camera devices installed at other locations. For example, the image collector 251 may request the CCTV camera device 100 installed at a location with many speeding vehicles to provide CCTV captured images with a first number of frames per second, and request the CCTV camera device installed at other locations to provide CCTV captured images with a second number of frames per second (e.g., a number less than the first number of frames per second). In an example, the image collector 251 may collect location information on a location where speeding vehicles occurred or a location where reports of speeding vehicles were received. The image collector 251 may request the CCTV camera device 100 installed at the location where the report was received to provide CCTV captured images with a number of frames per second corresponding to a pre-designated reference value. The image collector 251 may store the collected CCTV captured images 231 in the server memory 230 and request the object detector 252 to detect an object in the CCTV captured images 231. If the vehicle speed detection fails from the CCTV captured images captured with a specific frame per second (FPS) (or if there is no frame in which a specific part satisfying a predefined condition matches between a vehicle object and a reference object), the image collector 251 may request the CCTV camera device 100 to provide CCTV captured images captured with a higher FPS.

The object detector 252 can perform object recognition on the CCTV captured images 231 received from the CCTV camera device 100 and stored in the server memory 230 under the control of the image collector 251. In this regard, the object detector 252 may call the object detection algorithm 233 stored in the server memory 230 and use the object detection algorithm 233 to determine whether at least one vehicle is contained in the CCTV captured images 231. If at least one vehicle is contained, the object detector 252 may detect the vehicle object and a specific reference object or a plurality of reference objects. In this process, the object detector 252 may select frames from the CCTV captured images at a first interval according to a pre-designated frame sampling rate and detect the vehicle object and at least one reference object in the selected frames. The object detector 252 may transmit the detected vehicle object and reference object(s) in the frames to the speed calculator 253, or store the detected information in the server memory 230 and notify it to the speed calculator 253. When a request for frame adjustment is received from the speed calculator 253, the object detector 252 may change the frame sampling rate, select frames from the CCTV captured images at a second interval (e.g., an interval different from the first interval) according to the changed frame sampling rate, and detect the vehicle object and at least one reference object in the frames selected at the second interval. The object detector 252 may also transmit the changed frame sampling rate while delivering the vehicle object and at least one reference object extracted from the selected frames to the speed calculator 253 (or notifying the state stored in the server memory 230).

The speed calculator 253 may calculate the speed of the vehicle object based on the tracked vehicle object and at least one reference object extracted by the object detector 252 from the plurality of frames and stored in the server memory 230. In an example, the speed calculator 253 may detect a reference object (or a start reference point object) to be used as a start point for speed detection of the vehicle object among the reference objects, and then detect a reference object (or an intermediate reference point object or an end reference point object) to be used as an intermediate point or end point for speed detection of the vehicle object. In this case, the speed calculator 253 may select reference objects corresponding to the start and end positions by using reference objects detected from the CCTV captured images having no vehicle object, and the distance between the start and end positions may be obtained from an external input or information previously stored in the server memory 230. Thereafter, when a vehicle object is detected in the CCTV captured images containing a vehicle, the vehicle object is tracked to calculate the travel time of the vehicle object from the start position to the end position, and speed information of the vehicle object may be calculated using distance information between the start and end positions that has been obtained in advance.

In another example, the speed calculator 253 may obtain a first frame including a reference object having an end point (e.g., an end point of a specific line segment among dotted line lanes) that matches a front part of a vehicle object (e.g., a bumper or license plate of a vehicle) from the CCTV captured images including a vehicle, and designate the reference object of the first frame as a start reference point object. The speed calculator 253 may then obtain a second frame including a reference point object having an end point that matches the front part of the vehicle object among other reference point objects, and designate the reference point object of the second frame as an end reference point object for vehicle speed detection. The speed calculator 253 may calculate the travel time of the vehicle based on the number of frames between the start reference point object and the end reference point object (e.g., the number between the first frame and the second frame). In this process, the speed calculator 253 may calculate the number of frames between the first frame and the second frame in consideration of the frame sampling rate. When the travel time is calculated, the speed calculator 253 may calculate the travel distance of the vehicle object by using the number of reference objects located between the start reference point object and the end reference point object based on the reference object distance information 237 stored in the server memory 230. Since the actual spacing between reference objects may vary depending on the characteristics of the road or the structure installation plan, the speed calculator 253 may identify the location where the CCTV captured images 231 are received and obtain the reference object distance information corresponding to the location.

The speed calculator 253 may calculate the vehicle speed information 235 using the calculated vehicle travel time and the calculated vehicle travel distance, and store it in the server memory 230. When the detection of the vehicle speed information 235 is completed, the alarm processor 254 may be notified of this. If the detection of the start reference point object and the end reference point object is impossible, the speed calculator 253 may request the object detector 252 to adjust the frame sampling rate for the CCTV captured images. The speed calculator 253 may re-detect the vehicle speed information 235 using the vehicle objects and reference objects detected from frames with a narrower time interval according to the frame sampling rate adjustment. Through the above-described operation, the speed calculator 253 can precisely detect the vehicle speed regardless of the speed of the vehicle that violates the speed regulation, and can detect the vehicle speed for a vehicle that exceeds a certain standard.

When notified of the detection of vehicle speed information 235 from the speed calculator 253, the alarm processor 254 can compare it with the regulations set for the corresponding road 40 to determine whether or not the speed regulation has been violated. In this regard, the monitoring device 200 may obtain the regulation information set for the road 40 at the location where the CCTV captured images 231 are provided from a designated server device (e.g., a server device of a public institution that defines the speed regulations for the corresponding road 40) and store it in the server memory 230. When the alarm processor 254 detects the vehicle speed information 235 that violates the speed regulation, it can obtain identification information (e.g., vehicle license plate information) of the corresponding vehicle 41a, 41b, 41c, or 41d and transmit a message regarding the violation of the speed regulation based on this. For example, the alarm processor 254 may create a message regarding the occurrence of the situation (e.g., a message including identification information of a vehicle violating the speed limit and a location of the speed limit violation) and transmit the message to the designated user terminal 300 (e.g., a user terminal of an administrator managing the road 40). In an example, if a vehicle violates the speed limit by a predefined first criterion or more and a second criterion or less, the alarm processor 254 may create a warning message warning of the speed limit violation and transmit the warning message in a broadcast manner through a base station adjacent to the road 40 on which the vehicle is driving. Also, for a vehicle that violates the speed limit by more than the second standard, the alarm processor 254 may obtain vehicle identification information of the vehicle from the CCTV captured images and send a warning message warning of the violation of the speed limit to the user terminal 300 corresponding to the vehicle identification information or provide a warning about imposing a penalty. Also, the alarm processor 254 may control to transmit a warning message to an audio device or display device installed on the road 40 where a vehicle violating the speed limit is driving.

Meanwhile, the server processor 250 of the monitoring device 200 may extract reference point objects corresponding to the start and end positions of a lane from the CCTV captured images in the same way as measuring the speed of a vehicle, and store the distance of that section in advance. The server processor 250 may track each vehicle through a tracking model such as DeepSORT, measure the time it takes to reach the end position (or the end reference point object) from the start position (or the start reference point object), and calculate the speed of each vehicle through the distance recorded from the measured time. In this process, if it is difficult to detect a frame in which a specific part of the vehicle matches a start reference point object or an end reference point object, the server processor 250 may adjust the sampling rate of the frame to obtain a frame in which a specific part of the vehicle object matches the reference point objects, and calculate the vehicle speed based on this.

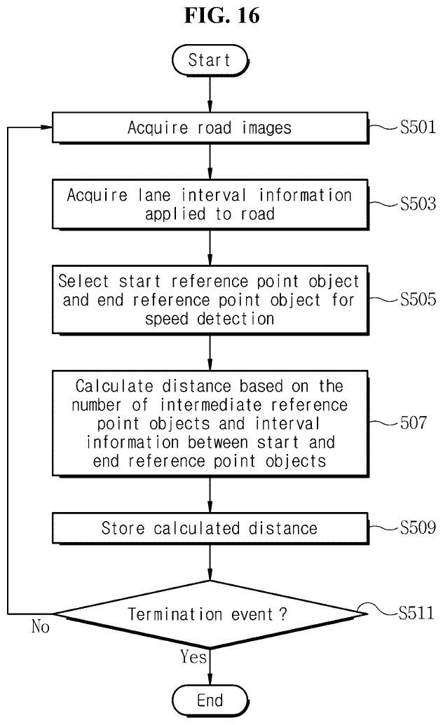

FIG. 16 is a flowchart illustrating one example of a vehicle speed detection method using CCTV captured images according to the second embodiment of the present disclosure. The vehicle speed detection method illustrated in FIG. 16 can be performed by the server processor 250 of the monitoring device 200 illustrated in FIG. 14.

Referring to FIG. 16, in step S501, the server processor 250 can acquire images of the road 40. For example, the server processor 250 may establish a communication channel with the CCTV camera device 100 and acquire the road image that does not contain the vehicle 41a, 41b, 41c, or 41d. In this regard, the server processor 250 may acquire an image having no detected vehicle among captured images provided by the CCTV camera device 100 as the road image. When the CCTV camera device 100 that captures images of the road 40 obtains a CCTV captured image that does not contain the vehicle 41a, 41b, 41c, or 41d, the CCTV camera device 100 may provide the road image to the server processor 250.

In step S503, the server processor 250 may acquire lane interval information applied to the road 40. The lane interval information applied to the road 40 may be pre-stored in the server memory 230 or obtained from an external server device that provides the lane interval information. For example, the lane interval information applied to the road 40 may include the length of each of the dotted lines drawn on the road 40 and the length of the interval between the dotted lines.

In step S505, the server processor 250 may select a start reference point object and an end reference point object for speed detection within the shooting range. For example, the server processor 250 may define, as the start reference point object, a specific point of a dotted line initially starting within the shooting range or a start point of a complete dotted line initially appearing within the shooting range among the detected dotted lines. In addition, the server processor 250 may select the last point of a dotted line that is lastly observed completely within the shooting range as the end reference point object.

In step S507, the server processor 250 may calculate a distance based on the number of intermediate reference point objects between the start reference point object and the end reference point object and based on the lane interval information. In this regard, by analyzing the road image, the server processor 250 may detect intermediate reference point objects located between the start reference point object and the end reference point object among the dotted lines located on the same virtual line in the same direction within the shooting range, and count the number of detected intermediate reference point objects. The server processor 250 may calculate the distance between the start reference point object and the end reference point object using the number of intermediate reference point objects and the lane interval information. Alternatively, the server processor 250 may determine the distance between the start reference point object and the end reference point object based on an external input (e.g., an administrator input or information input provided by an external server device).

In step S509, the server processor 250 may store the calculated distance in the server memory 230. Additionally, the server processor 250 may store the positions of the start and end reference point objects and, when detecting vehicle objects 41a, 41b, 41c, and 41d at a later time, use them to calculate the travel times of the vehicle objects 41a, 41b, 41c, and 41d passing through the start and end reference point objects. For example, the server processor 250 may track (e.g., DeepSORT) a vehicle object entering the start reference point object to calculate the travel time to the end reference point object, and may detect speed information of the vehicle object using pre-stored distance information.

In step S511, the server processor 250 may check whether there is an occurrence of a termination event requesting the termination of the distance information calculation function in a certain section of the road 40. If there is no occurrence of the termination event, the server processor 250 may repeatedly perform steps S501 to S509 a specified number of times and determine the distance between the start reference point object and the end reference point object using the average of the calculated information.

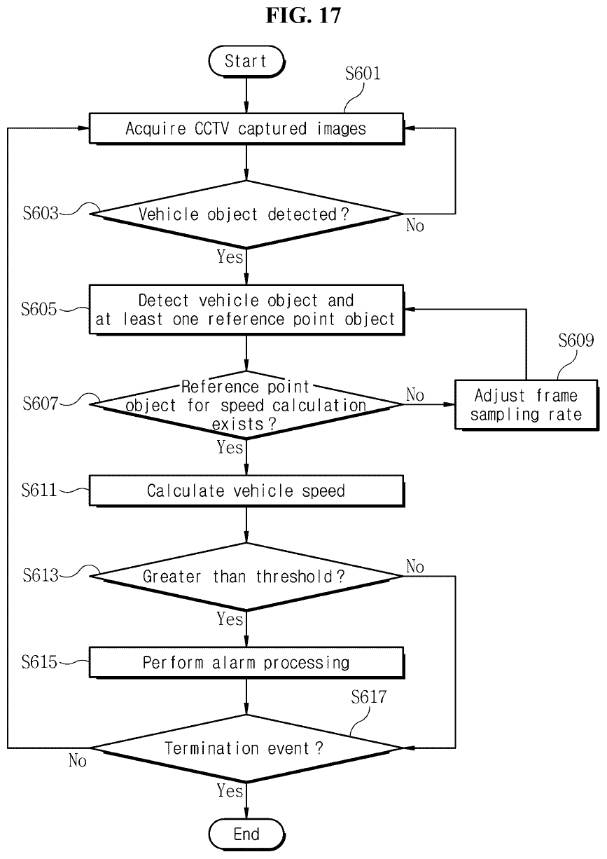

FIG. 17 is a flowchart illustrating another example of a vehicle speed detection method using CCTV captured images according to the second embodiment of the present disclosure. The vehicle speed detection method illustrated in FIG. 17 can be performed by the server processor 250 of the monitoring device 200 illustrated in FIG. 14.

Referring to FIG. 17, in step S601, the server processor 250 may acquire CCTV captured images. In this regard, the server processor 250 may establish a communication channel with the CCTV camera device 100 and acquire captured images from the CCTV camera device 100. For example, the server processor 250 may acquire a high-speed or low-speed CCTV captured images according to pre-designated schedule information or according to an administrator input. The high-speed CCTV captured images may include captured image with a relatively high number of frames per second compared to the low-speed CCTV captured images. In other words, the low-speed CCTV captured images may include captured images with a relatively low number of frames per second compared to the high-speed CCTV captured images. For example, the number of frames per second of the high-speed CCTV captured images may be 30 frames (this is an example and may be changed), and the number of frames per second of the low-speed CCTV captured images may be 15 frames (this is an example and may be changed).

In step S603, the server processor 250 may check whether a vehicle object is detected in the acquired CCTV captured images. In this regard, the server processor 250 may call the object detection algorithm 233 pre-stored in the server memory 230 and detect the vehicle object in the CCTV captured images using the object detection algorithm 233. If the vehicle object is not detected, the server processor 250 may return to the step S601 and re-perform the subsequent operations. Meanwhile, the CCTV camera device 100 may capture a designated lane and, if the CCTV captured images contain a vehicle object, provide the CCTV captured images to the server processor 250. In this case, the server processor 250 may skip the step S603.

If the vehicle object is detected in the CCTV captured images, in step S605, the server processor 250 may also detect at least one reference point object. In this process, the server processor 250 may detect reference point objects having a repeating pattern that can be used to detect the speed of the vehicle object. For example, the server processor 250 may detect line segments of a dotted line printed on the road 40 as the reference point objects. Alternatively, the server processor 250 may detect repeating structures installed on the road 40 (e.g., a centerline divider, a guide rail for preventing departure from the road 40) as the reference point objects. Alternatively, the server processor 250 may detect a reference point object whose length is known in advance. Also, the server processor 250 may select frames at a first interval from the CCTV captured images according to a predefined frame sampling rate, and detect the vehicle object and the at least one reference point object in the frames selected at the first interval. For example, the server processor 250 may select one frame per five frames (this is an example and may be varied) and detect at least one reference point object while tracking and detecting identical vehicle objects in the selected frames.

In step S607, the server processor 250 may determine whether there is a frame including at least one reference point object for speed calculation. For example, the server processor 250 may check whether there is a frame that includes at least one reference point object having a point (e.g., an end of the object) coinciding with a part of a vehicle object.

If there is no frame including at least one reference point object for speed calculation, the server processor 250 may adjust a frame sampling rate in step S609. For example, the server processor 250 may set the interval for selecting frames to be narrower. For example, the server processor 250 may select frames from the CCTV captured images at a second interval (e.g., one every three frames). Thereafter, in the step S605, the server processor 250 may detect a vehicle object and at least one reference point object in the more densely selected frames, and in step S607, may determine whether there is a frame including at least one reference point object for speed calculation. Additionally, if there is no frame including a reference point object for speed calculation, the server processor 250 may provide a control signal to the CCTV camera device 100 requesting to capture the CCTV images at a higher frame rate, and may receive the corresponding CCTV captured images.

If there is a frame including at least one reference point object for speed calculation, in step S611, the server processor 250 may calculate a vehicle speed. For example, the server processor 250 may check the number of frames between a first frame including one end of a reference point object matching a part of the vehicle and a second frame including the other end, calculate a travel time of the vehicle, and obtain a length of the reference point object from the server memory 230. Then, based on the calculated travel time of the vehicle and the obtained length of the reference point object, the server processor 250 can calculate the speed of the vehicle. Meanwhile, in the above description, the speed of the vehicle object is calculated based on one reference point object, but the present disclosure is not limited thereto. For example, the server processor 250 may detect a first frame including a first reference point object having an end that matches a designated part of the vehicle, detect at least one second frame including at least one second reference point object, and then calculate the travel time of the vehicle based on the order of the detected frames. In addition, the server processor 250 may obtain information about intervals between reference point objects from the server memory 230 and calculate the travel distance of the vehicle. In the above-described process, the server processor 250 may apply a frame sampling rate when calculating the time between the first frame and the second frame.

In step S613, the server processor 250 may check whether the calculated speed value is greater than a threshold value. The threshold value refers to a speed value set on the road 40 where the CCTV camera device 100 captures images, and may include a value for determining whether or not there is speeding.

If the calculated speed value is greater than the threshold value, in step S615, the server processor 250 may perform designated alarm processing. For example, the server processor 250 may obtain license plate information of the vehicle 41a, 41b, 41c, or 41d from the CCTV captured images received from the CCTV camera device 100, and provide the obtained license plate information of the vehicle and evidence of speeding (e.g., CCTV captured images) to a designated external server device (e.g., a device operated by a government office that imposes a fine for speeding or takes administrative measures accordingly). Alternatively, the server processor 250 may obtain a registered number of the user terminal 300 together with the license plate information of the vehicle, and notify speeding and corresponding penalty to the user through the corresponding number of the user terminal 300. If the calculated speed value is less than the threshold value, step S615 may be skipped.

In step S617, the server processor 250 may check whether a monitoring termination event (e.g., an event in which a time set for speeding enforcement has elapsed, an event in which speeding enforcement is stopped by administrator input) has occurred. If the termination event has occurred, the related function can be terminated. If no termination event has occurred, the server processor 250 may return to the step S601 and re-perform the subsequent operations.

### Third Embodiment

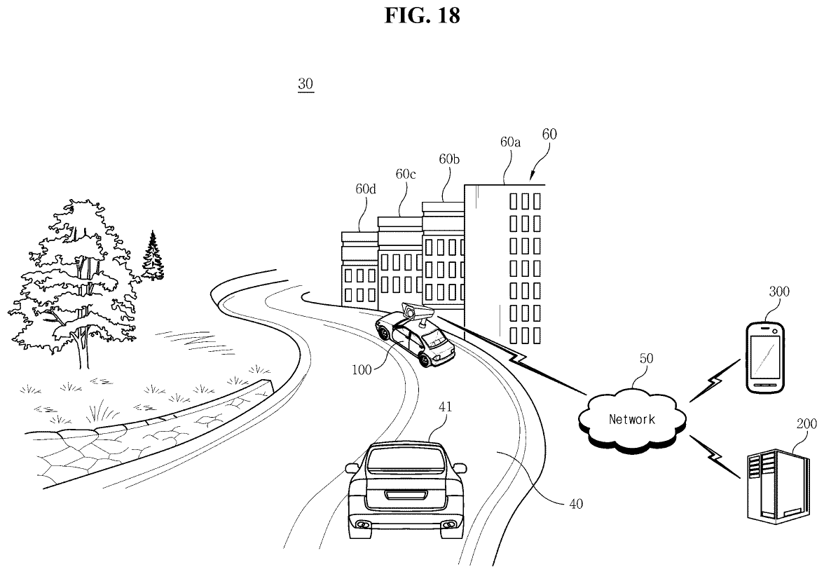

Hereinafter, the first embodiment of the present disclosure will be described with reference to FIGS. 18 to 23.

FIG. 18 is a schematic diagram illustrating an example of a vehicle speed detection environment according to the third embodiment of the present disclosure.

Referring to FIG. 18, the vehicle speed detection environment 30 corresponds to a case where the speed of a vehicle is detected using a mobile CCTV camera device. The vehicle speed detection environment 30 may include a road 40, vehicles 41 driving on the road 40, a mobile CCTV camera device 100 that obtains CCTV captured images of the vehicles 41, a network 50, a monitoring device 200, and a user terminal 300. In the case where the monitoring device 200 is integrated into the mobile CCTV camera device 100, the network 50 and the user terminal 300 may be omitted from the vehicle speed detection environment 30.

The road 40 may include an area where a video is recorded (i.e., images are captured) by the mobile CCTV camera device 100. The vehicles 41 may drive on the road 40. In particular, at least one structure 60 that can be used to detect the speed of the vehicle 41 may be arranged on or around the road 40. For example, the at least one structure 60 may include a plurality of structures 60a, 60b, 60c, and 60d arranged around the road 40. The plurality of structures 60a, 60b, 60c, and 60d may include an overpass or an elevated road installed on the road 40. In addition, the plurality of structures 60a, 60b, 60c, and 60d may include a plurality of buildings arranged continuously adjacent to the road 40.

The mobile CCTV camera device 100 may be positioned to acquire CCTV captured images of at least a portion of the road 40. For example, the mobile CCTV camera device 100 may be parked or hovered at the edge of the road 40 or around the road 40 so as to capture images of the road 40 at a certain angle. The mobile CCTV camera device 100 may capture images of a certain area of the road 40 including the at least one structure 60 and the vehicle 41. The mobile CCTV camera device 100 may include a member for moving. When the mobile CCTV camera device 100 is a vehicle, the member for moving the mobile CCTV camera device 100 may include, for example, a plurality of wheels, a power device capable of rotating the plurality of wheels, a steering device capable of controlling the direction of travel of the plurality of wheels, an acceleration device for controlling speed, and a brake device. Alternatively, if the mobile CCTV camera device 100 is a drone device, the moving member of the mobile CCTV camera device 100 may include a plurality of propellers and a propeller control device for controlling the direction and speed of the plurality of propellers. The mobile CCTV camera device 100 may include a location information collector for moving to a designated location on the road 40 and a CCTV camera for capturing images of the vehicles 41 driving on the road 40.

When the mobile CCTV camera device 100 is placed at a specific location on the road 40, the mobile CCTV camera device 100 may collect map information corresponding to the current location and identify at least one surrounding structure 60 through the collected map information. The mobile CCTV camera device 100 may collect information about the at least one structure 60 (e.g., size information of a building or length information of one side of a building adjacent to the road 40). The length information about the at least one structure 60 may be obtained from a separate server device that provides information about the corresponding structure 60 (e.g., a server device of a public institution that stores and manages information about the structure 60). Alternatively, when the map information provides the length information about the structure 60, the mobile CCTV camera device 100 may identify the length information about the structure 60 through the map information. Alternatively, the mobile CCTV camera device 100 may obtain map information corresponding to a plurality of structures 60a, 60b, 60c, and 60d and collect distance information between the structures 60a, 60b, 60c, and 60d on the map information.

The mobile CCTV camera device 100 may collect CCTV captured images (or a video including a plurality of frames) of the road 40 according to preset schedule information or in response to the control of the monitoring device 200, and transmit the collected CCTV captured images to the monitoring device 200. In another example, the mobile CCTV camera device 100 may adjust the number of frames per second of the CCTV captured images to be captured according to the setting or the request of the monitoring device 200. For example, the mobile CCTV camera device 100 may collect the CCTV captured images (e.g., low-speed CCTV captured images) based on a first number of frames per second, or collect the CCTV captured images (e.g., high-speed CCTV captured images) based on a second number of frames per second. The second number may be greater than the first number.

The monitoring device 200 (or referred to as a server device, a vehicle speed detection device, a speeding vehicle detection device, etc.) may provide the mobile CCTV camera device 100 with location information of the specific road 40 where the mobile CCTV camera device 100 is to capture images, and receive the CCTV captured images of the road 40 at a designated location from the mobile CCTV camera device 100. If the location information of the road 40 is stored in advance in the mobile CCTV camera device 100, the operation of the monitoring device 200 providing the location information of the road 40 may be omitted.

The monitoring device 200 may receive the CCTV captured images and perform vehicle speed detection for the vehicle 41 based on the received CCTV captured images. In this process, the monitoring device 200 may detect a structure object corresponding to the at least one structure 60 in the CCTV captured images and select frames in which the structure object and the vehicle object satisfy specified conditions. The monitoring device 200 may calculate the travel time of the vehicle object by using the selected frames and calculate the speed information of the vehicle 41 by using the length information of the structure object (or the distance information between structures) through the map information.

In another example, the monitoring device 200 may select frames at a first interval according to a preset frame sampling rate for the CCTV captured images provided by the mobile CCTV camera device 100, and detect frames that satisfy a predefined condition from among the selected frames, for example, frames in which a specific part of the vehicle object matches a specific part of the structure object. The monitoring device 200 may calculate the travel time of the vehicle 41 based on the interval of the detected frames, obtain the length information or distance information of the structure object from the map information, and then calculate the speed of the vehicle 41 by using the calculated travel time and the obtained length information or distance information. In this process, the monitoring device 200 may set one point and another point of the structure object as the start point and the end point for vehicle speed detection, respectively. Alternatively, the monitoring device 200 may set one point of the first structure object and one point of the second structure object as the start point and the end point for vehicle speed detection, respectively.

When the speed of the detected vehicle 41 is greater than a predefined reference value, the monitoring device 200 may obtain information on the license plate of the vehicle 41, set a speed violation marking on the vehicle 41, and then output the relevant information to a display or provide it to a designated server device (e.g., a computing device operated by a government office). In addition, if the degree of speed violation is within a predefined guide range, the monitoring device 200 may obtain a user phone number registered together with the vehicle license plate information, and transmit a guide message related to the speed violation to the corresponding user through the obtained user phone number.

The user terminal 300 has been described in the second embodiment above, so a duplicate description will be omitted.

Similarly, the network 50 has been described in the second embodiment above, so a duplicate description will be omitted.

In the above-described vehicle speed detection environment 30 according to the third embodiment, it is possible to support detecting the speed of the vehicle 41 by using the mobile CCTV camera device 100 even in an area where no fixed CCTV device is installed. In this process, the speed of the vehicle 41 can be detected using only the CCTV captured images without a speedometer. In addition, the power efficiency of the mobile CCTV camera device 100 can be increased, and the maintenance cost of the mobile CCTV camera device 100 can be saved, thereby enabling more efficient vehicle speed detection.

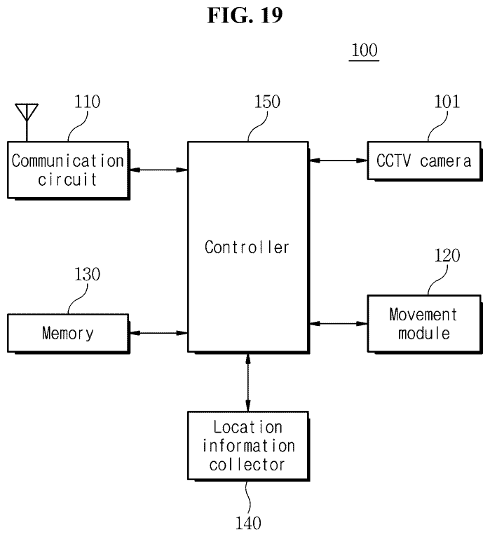

FIG. 19 is a block diagram illustrating the configuration of a mobile CCTV camera device according to the third embodiment of the present disclosure.

Referring to FIG. 19, the mobile CCTV camera device 100 according to the third embodiment may include a CCTV camera 101, a communication circuit 110, a movement module 120, a memory 130, a location information collector 140, and a controller 150.

The CCTV camera 101 can capture still images or video of a certain area of the road 40 when the mobile CCTV camera device 100 is placed at a certain location on the road 40. For example, the CCTV camera 101 may collect CCTV captured images based on a shooting angle that includes at least one structure 60 and a certain area of the road 40. Under the control of the controller 150, the CCTV camera 101 may collect CCTV captured images of the road 40 and temporarily store them in the memory 130 or provide them to the monitoring device 200. In another example, under the control of the controller 150, the CCTV camera 101 may collect CCTV captured images at a first frame per second (FPS) speed or a second FPS speed that is faster (or slower) than the first FPS speed. That is, the CCTV camera 101 may collect low-speed CCTV captured images at the first FPS speed or high-speed CCTV captured images at the second FPS speed.

The communication circuit 110 may include at least one communication module for establishing a communication channel of the mobile CCTV camera device 100. The communication circuit 110 is substantially the same as the communication circuit (110 in FIG. 13) described in the second embodiment above, so a duplicate description is omitted.

The movement module 120 may include at least one module for performing the movement of the mobile CCTV camera device 100. For example, if the mobile CCTV camera device 100 is a vehicle, the movement module 120 may include a plurality of wheels, a power generation device for generating power to be transmitted to the plurality of wheels, at least one shaft and gear for transmitting the generated power to the plurality of wheels, a steering device for performing steering for the direction of movement of the mobile CCTV camera device 100, an acceleration device and a brake device for controlling the speed of the mobile CCTV camera device 100, and a body forming the exterior of the mobile CCTV camera device 100. In addition, if the mobile CCTV camera device 100 is a drone device, the movement module 120 may include at least one propeller, a power device for providing power to the propeller, and a control device for controlling the direction and speed of the propeller. The above-described moving module 120 can move the mobile CCTV camera device 100 in response to the control of the controller 150.

The memory 130 can store data or programs related to the operation of the mobile CCTV camera device 100. For example, the memory 130 may receive CCTV captured images from the CCTV camera 101 at regular intervals or in real time and store them temporarily or semi-permanently. The CCTV captured images stored in the memory 130 may include, for example, at least one of low-speed CCTV captured images and high-speed CCTV captured images. The memory 130 may store location information and surveillance time information for detecting the speed of the vehicle 41. The memory 130 may store map information.

The location information collector 140 can collect location information of the mobile CCTV camera device 100. For example, the location information collector 140 may include a GPS information collection device. The location information collector 140 may collect current location information (or current GPS information) under the control of the controller 150 and provide the collected current location information to the controller 150. The location information collected by the location information collector 140 may also be provided to the monitoring device 200 under the control of the controller 150.

The controller 150 can perform transmission and processing of signals related to control of the mobile CCTV camera device 100 and storage or transmission of the processing results. In an example, the controller 150 may receive location information and time information of the road 40 to be monitored from the monitoring device 200. The controller 150 may identify the received location information and control the movement module 120 for movement to the corresponding location. In this process, the controller 150 may collect the current location in real time by using the location information collector 140 to identify where the mobile CCTV camera device 100 is currently located. If the location information provided by the monitoring device 200 and the current location match, the controller 150 may control to collect the CCTV captured images of the road 40 at the designated location (or the current location).

In an example, the controller 150 may collect surrounding captured images by using the CCTV camera 101 at the current location. The controller 150 may detect at least one structure 60 to be used for speed detection of the vehicle 41 from the surrounding captured images. In this process, by performing a YOLO model or an edge detection method, the controller 150 may detect the at least one structure 60 from the surrounding captured images. Upon detecting the at least one structure 60, the controller 150 may detect direction information in which the at least one structure 60 is arranged based on the current location of the mobile CCTV camera device 100, and match the direction information and the current location information with the map information stored in the memory 130. Through matching with the map information, the controller 150 may identify the at least one structure 60 on the map information. For example, the controller 150 may identify what kind of building (or structure) the at least one structure 60 is on the map information.

The controller 150 may collect distance information to be used for speed detection of the vehicle 41 by using the at least one identified structure 60. For example, when a plurality of structures 60a, 60b, 60c, and 60d are detected, the controller 150 may convert distances between the plurality of structures 60a, 60b, 60c, and 60d on the map information into actual distances by using the scale of the map to calculate distance information. In another example, the distance information calculation operation may be performed in the monitoring device 200, and in this case, the controller 150 may provide the collected surrounding captured images to the monitoring device 200 without performing a separate calculation operation. After providing the surrounding captured images to the monitoring device 200, the controller 150 may receive capture direction information from the monitoring device 200, collect the CCTV captured images in a direction that includes the road 40 and the at least one structure 60 according to the received capture direction, and provide the CCTV captured images to the monitoring device 200.

The controller 150 may adjust the frame rate of the CCTV camera 101 according to preset conditions (e.g., region or time) or under the control of the monitoring device 200. For example, the controller 150 may increase the frame rate per second of the CCTV camera 101 when the number of vehicles 41 on the road 40 is less than a predefined first criterion and thus the vehicles are likely to speed, and may decrease the frame rate per second of the CCTV camera 101 when the number of vehicles 41 on the road 40 is more than a predefined second criterion and thus the vehicles are unlikely to speed. The number of vehicles 41 may be received from the monitoring device 200 or identified through vehicle object detection in the mobile CCTV camera device 100. Additionally or alternatively, the controller 150 may increase the number of frames per second of the CCTV camera 101 during times when speeding vehicles are frequent statistically or empirically, and may decrease the number of frames per second of the CCTV camera 101 during times when speeding vehicles are rare. Depending on at least one of the time zone, location, and request, the controller 150 may provide the CCTV captured images of different frames per second (FPS) to the monitoring device 200.

The mobile CCTV camera device 100 may be configured to perform at least some of the steps for detecting vehicle speed, depending on whether a related function is supported. For example, the mobile CCTV camera device 100 may be configured to simply collect the CCTV captured images including the road 40 and the at least one structure 60 at one point on the road 40 and transmit them to the monitoring device 200. Alternatively, the mobile CCTV camera device 100 may be configured to perform a surrounding captured image analysis, determine a capture direction including the at least one structure 60 and the road 40, collect the CCTV captured images in the determined direction, and transmit the collected images to the monitoring device 200. Alternatively, the mobile CCTV camera device 100 may detect the speed of the vehicle 41 from the CCTV captured images, and when the vehicle 41 that violates the speed limit is detected, provide the detected images to the monitoring device 200. In this process, if the corresponding function is supported, the mobile CCTV camera device 100 may identify the license plate information of the vehicle 41 and provide it to the monitoring device 200.

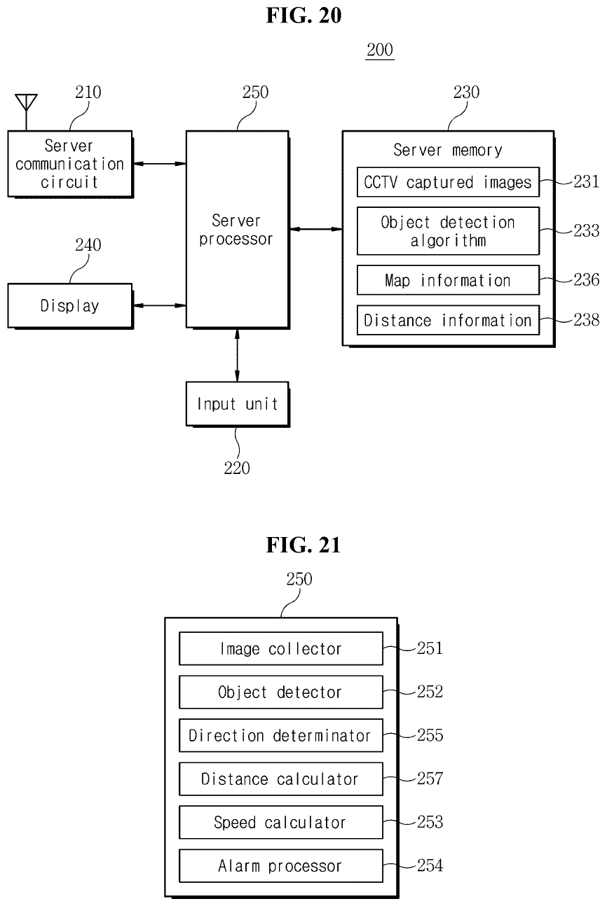

FIG. 20 is a block diagram illustrating the configuration of a monitoring device according to the third embodiment of the present disclosure.

Referring to FIG. 20, the monitoring device 200 (also referred to as a server device, a vehicle speed detection device, or a speeding vehicle detection device) may include a server communication circuit 210, an input unit 220, a server memory 230, a display 240, and a server processor 250.

The server communication circuit 210 can support the formation of a communication channel of the monitoring device 200. The server communication circuit 210 is substantially the same as the server communication circuit (210 in FIG. 14) described in the second embodiment above, so that a duplicate description is omitted.

The input unit 220 may include components that support administrator's inputs related to the operation of the monitoring device 200. The input unit 220 is substantially the same as the input unit (220 in FIG. 14) described in the second embodiment above, so that a duplicate description is omitted.

The server memory 230 can store at least one of data and programs related to the operation of the monitoring device 200. For example, the server memory 230 may include (or store) at least one of CCTV captured images 231, an object detection algorithm 233, map information 236, and distance information 238.

The CCTV captured images 231 may include CCTV captured images having the same or different frames per second, received from the mobile CCTV camera device 100. For example, the CCTV captured images 231 may include at least one CCTV captured images provided by the CCTV camera 101 in real time, at regular intervals, or upon request with respect to the road 40. The CCTV captured images 231 may contain at least one vehicle 41 and at least one structure object.

The object detection algorithm 233 may include an algorithm or program capable of recognizing and detecting, from each of the CCTV captured images 231, the at least one vehicle 41 and the at least one structure object located around the vehicle 41.

The map information 236 may include a map of a certain area including the location where the mobile CCTV camera device 100 is currently located. The map information 236 may include, for example, road information corresponding to the road 40 to be monitored by the mobile CCTV camera device 100, and structure information corresponding to the at least one structure 60 placed on or adjacent to the road 40 at a certain scale.

The distance information 238 may include a distance value between points of the at least one structure 60 to be used for speed detection of the vehicle 41. In an example, the distance information 238 may include a distance value between a point of a first structure and a point of a second structure among a plurality of structures included in the map information 236. Additionally or alternatively, the distance information 238 may include a distance value between two points of a certain structure included in the map information 236. In another example, the distance information 238 may be stored by an administrator input or may be received from an external server device that provides length information of the at least one structure 60 or distance information between the structures 60a, 60b, 60c, and 60d.

The display 240 can output at least one screen related to the operation of the monitoring device 200. The display 240 is substantially the same as the display (240 in FIG. 14) described in the second embodiment above, so a duplicate description is omitted.

The server processor 250 can perform operations of receiving, transmitting, and processing signals related to the operation of the monitoring device 200, and storing or transmitting the result of processing. For example, the server processor 250 may provide the mobile CCTV camera device 100 with location information and time information about the road 40 to be monitored according to preset scheduling information or an administrator input. The server processor 250 may receive surrounding captured images from the mobile CCTV camera device 100 that has arrived at a designated location, determine a capture direction of the mobile CCTV camera device 100 based on the received surrounding captured images, and provide the determined capture direction information to the mobile CCTV camera device 100.

The server processor 250 may receive the CCTV captured images 231 from the mobile CCTV camera device 100, detect the vehicle object and the at least one structure object from the received CCTV captured images 231 by using the object detection algorithm 233, and perform speed detection of the vehicle based on the detected information. In addition, the server processor 250 may perform vehicle speed detection for one vehicle and, if the CCTV captured images contain a plurality of vehicles, perform vehicle speed detection for each of the vehicles. In this regard, the server processor 250 may include a configuration as illustrated in FIG. 21.

FIG. 21 is a block diagram illustrating the configuration of a server processor in the monitoring device shown in FIG. 20.

Referring to FIG. 21, the server processor 250 may include an image collector 251, an object detector 252, a direction determinator 255, a distance calculator 257, a speed calculator 253, and an alarm processor 254.

The image collector 251 can generate a control signal related to the control of the mobile CCTV camera device 100 and transmit the generated control signal to the mobile CCTV camera device 100 via the network 50. In an example, the image collector 251 may collect location information and time information related to the road 40 to be monitored by the mobile CCTV camera device 100 and provide the location information and the time information to the mobile CCTV camera device 100. The location information and time information related to the road 40 to be monitored may be pre-stored in the server memory 230 or input by an administrator.

The image collector 251 may generate a control signal related to the turn-on or turn-off control of the CCTV camera 101 according to preset scheduling information or an administrator input signal. The image collector 251 may provide a status related to the control of the CCTV camera device 100 to the display 240 of the monitoring device 200. In another example, the image collector 251 may control to provide CCTV captured images from the CCTV camera 101 and transmit the received CCTV captured images to the object detector 252 or notify the storage of the CCTV captured images 231 to the object detector 252. In an example, the image collector 251 may generate a control signal for adjusting a capture speed (or the number of captured frames per second) of the CCTV camera 101 according to at least one of time, location, and request, transmit the generated control signal to the mobile CCTV camera device 100, and collect the CCTV captured images having the corresponding number of captured frames per second. In response to this, the image collector 251 may collect low-speed CCTV captured images or high-speed CCTV captured images. For example, the image collector 251 may store the collected CCTV captured images 231 in the server memory 230 and request object detection for the CCTV captured images 231 from the object detector 252. If the image collector 251 fails to detect the speed of the vehicle through the CCTV captured images captured at a specific frame per second (FPS) (or if there is no frame in which a specific part satisfying a predefined condition matches between a vehicle object and a structure object), the image collector 251 may request the mobile CCTV camera device 100 to provide CCTV captured images with a higher FPS.

The object detector 252 can perform object recognition on the CCTV captured images 231 received from the mobile CCTV camera device 100 and stored in the server memory 230 under the control of the image collector 251. In this regard, the object detector 252 may call the object detection algorithm 233 stored in the server memory 230 and use the object detection algorithm 233 to determine whether at least one vehicle 41 is detected in a specific frame of the CCTV captured images 231. If the at least one vehicle is detected, the object detector 252 may detect a vehicle object and a specific structure object or a vehicle object and a plurality of structure objects in the CCTV captured images 231. In this process, the object detector 252 may select frames at a first interval from the CCTV captured images according to a pre-designated frame sampling rate and detect the vehicle object and at least one structure object in the frames at the selected first interval. In relation to detection of at least one structure object, the object detector 252 may distinguish the at least one structure object from the CCTV captured images by using a YOLO model or an edge detection method.

The object detector 252 may transmit the vehicle object and the plurality of structure objects in the detected plurality of frames to the speed calculator 253, or store the detected information in the server memory 230 and notify this storage to the speed calculator 253. Meanwhile, when a request for frame adjustment is received from the speed calculator 253, the object detector 252 may change the frame sampling rate, select frames from the CCTV captured images at a second interval (e.g., an interval different from the first interval) according to the changed frame sampling rate, and detect the vehicle object and the at least one structure object in the frames selected at the second interval. The object detector 252 may also transmit the changed frame sampling rate while delivering the vehicle object and at least one structure object extracted from the frames selected at the second interval to the speed calculator 253 (or notifying the state stored in the server memory 230).

The direction determinator 255 can determine the capture direction of the mobile CCTV camera device 100. The direction determinator 255 may identify the vehicle object and at least one structure object detected by the object detector 252 and determine whether the vehicle object and at least one structure object satisfy a predefined reference condition. For example, the direction determinator 255 may identify whether there is a frame in which a specific part of the vehicle object matches a point of the at least one structure object. If there is no matching frame, the direction determinator 255 may calculate an angle (or direction) at which the at least one structure 60 and the road 40 can be captured at a different capture angle from a previous capture angle, and provide the calculated angle information (or direction information) to the mobile CCTV camera device 100. The mobile CCTV camera device 100 may change direction according to a control signal (e.g., a control signal requesting a change in direction information) received from the direction determinator 255, collect the CCTV captured images according to the changed direction, and provide them to the monitoring device 200. When a frame satisfying a specified condition is detected, the direction determinator 255 may request distance calculation from the distance calculator 257.

The distance calculator 257 can perform distance calculation for the at least one detected structure object according to a request from the direction determinator 255. For example, the distance calculator 257 may detect the at least one structure object having a point that matches a specific part of the vehicle 41. In an example, the distance calculator 257 may detect a first structure object and a second structure object each having an edge that matches a front bumper part of the vehicle 41. When the first and second structure objects are detected, the distance calculator 257 may call the map information 236 based on the current location information of the mobile CCTV camera device 100 and identify the first and second structures on the map information that match the first and second structure objects on the map information 236. The distance calculator 257 may identify the scale of the map information and apply the scale to the distance on the map between the first and second structures to calculate the distance between the first and second structure objects. In another example, the distance calculator 257 may detect a structure object having a first edge and a second edge that match a specific part of the vehicle 41, and match the structure object having the first and second edges to a specific structure on the map information 236. The distance calculator 257 may calculate the length information between the first and second edges as the distance information based on the information about the structure on the map information 236.

The speed calculator 253 can calculate the speed of the vehicle object, based on the tracked vehicle object and at least one structure object extracted from a plurality of frames by the object detector 252 and stored in the server memory 230 and based on the distance information calculated by the distance calculator 257. In an example, the speed calculator 253 may detect a first structure object (e.g., a start point for speed detection of the vehicle 41) having a point that matches a specific part of the vehicle object in the CCTV captured images, and a second structure object (e.g., an end point for speed detection of the vehicle 41) having a point that matches a specific part of the vehicle object. The speed calculator 253 may calculate the travel time of the vehicle 41, based on the number of frames between the first frame in which the first structure object is detected and the second frame in which the second structure object is detected. The speed calculator 253 may calculate the speed of the vehicle 41, based on the calculated travel time and the distance information between the first and second structure objects.

In another example, from the CCTV captured images containing a vehicle object, the speed calculator 253 may obtain a first frame in which a start portion of the vehicle object (e.g., a vehicle's bumper or license plate) and a first point (or a first corner) of a first structure object coincide, and may obtain a second frame in which a start portion of the vehicle object and a second point (or a second corner) of the first structure object coincide. The speed calculator 253 may calculate the travel time of the vehicle 41, based on the number of frames between the first frame and the second frame, and may calculate the speed of the vehicle 41 by using the distance information between the first and second points of the first structure object and the travel time, based on the map information 236.

The alarm processor 254 can receives the speed of the vehicle 41 from the speed calculator 253 and compare it with the regulation set for the corresponding road 40 to determine whether or not the speed regulation has been violated. In this regard, the alarm processor 254 may obtain the regulation information set for the road 40 at the location corresponding to the CCTV captured images 231 from a designated server device (e.g., a server device of a public institution that defines the speed regulation for the corresponding road 40) and store it in the server memory 230. When the vehicle 41 violating the speed regulation is detected, the alarm processor 254 may obtain the identification information (e.g., vehicle license plate information) of the vehicle 41 and transmit a message regarding the speed regulation violation based on the obtained information. For example, the alarm processor 254 may create a message regarding the occurrence of the situation (e.g., a message including identification information of a vehicle violating the speed limit and a location of the speed limit violation) and transmit it to the designated user terminal 300 (e.g., a user terminal of an administrator managing the road 40). In an example, if a vehicle violates the speed limit by more than a first criterion and less than a second criterion, the alarm processor 254 may create a warning message for violating the speed limit and transmit the warning message in a broadcast manner through a base station adjacent to the road 40 on which the vehicle is driving. Also, for a vehicle that violates the speed limit by more than the second standard, the alarm processor 254 may obtain vehicle identification information of the vehicle from the CCTV captured images and transmit a warning message for violating the speed limit to the user terminal 300 related to the vehicle identification information or provide a warning about imposing a penalty. Also, the alarm processor 254 may control to transmit a warning message to an audio device or a display device installed on the road 40 where a vehicle violating the speed limit is driving.

In the above-described vehicle speed detection environment 30 using the mobile CCTV camera device 100 according to the third embodiment, it is possible to detect the speed of the vehicle 41 by selecting a structure object to be used for vehicle speed detection through matching the map information 236 with at least one structure placed around the road 40 for a point on the road 40 requiring surveillance, thereby supporting detection of the speed of the vehicle 41 without a separate speedometer or actual measurement process for the structure.

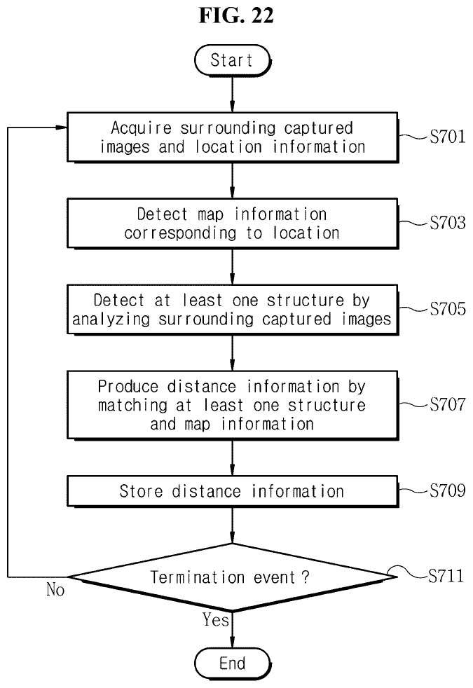

FIG. 22 is a flowchart illustrating a reference distance setting method based on a mobile CCTV camera device according to the third embodiment of the present disclosure. The reference distance setting method illustrated in FIG. 22 can be performed by the server processor 250 of the monitoring device 200 illustrated in FIG. 20.

Referring to FIG. 22, in step S701, the server processor 250 may acquire surrounding captured images including at least one structure (e.g., at least one landmark) arranged around the road 40 on which the vehicle 41 may drive. In this regard, the server processor 250 may establish a communication channel with the mobile CCTV camera device 100 and obtain the surrounding captured images satisfying the above-mentioned conditions from the mobile CCTV camera device 100. Here, the location information of the road 40 may be provided by the monitoring device 200. When the monitoring device 200 provides the location information (or both location information and time information) of the road 40 to the mobile CCTV camera device 100, the mobile CCTV camera device 100 may move to a location corresponding to the received location information and collect the surrounding captured images including the road 40 at the location.

In step S703, the server processor 250 may detect map information corresponding to the location of the surrounding captured images. In this regard, the mobile CCTV camera device 100 may collect the corresponding location information while collecting the captured images and provide the collected location information to the server processor 250. If the location information is provided by the monitoring device 200, the process of transmitting and receiving the location information of the surrounding captured images may be omitted. The server processor 250 may search for the map information 236 based on the collected location information and detect the map information 236 including a certain area corresponding to the same location.

In step S705, the server processor 250 may analyze the surrounding captured images and thereby detect at least one structure. For example, the server processor 250 may identify at least one structure included in the surrounding captured images through the YOLO model or the edge detection method. In an example, the server processor 250 may analyze the surrounding captured images and identify a certain area of the road 40 that matches the shape and relative position of at least one structure from the map information 236. Also, the server processor 250 may obtain 3D images for a direction indicated based on the current position from the map information 236 and detect a certain 3D image that matches an image including at least one structure among the 3D images.

When the at least one structure is detected, the server processor 250 may produce the distance information 238 by matching the at least one structure with the map information in step S707. For example, the server processor 250 may select a first structure (e.g., the closest structure based on the point where the surrounding captured images are acquired, the start position for speed detection of the vehicle 41) and a second structure (e.g., the structure observed farthest based on the point where the surrounding captured images are acquired, the end position for speed detection of the vehicle 41) among a plurality of structures in the map information 236, and may calculate the distance information 238 between the first structure and the second structure by applying the scale of the map information 236 to the distance between the first structure and the second structure on the map information 236.

In step S709, the server processor 250 may store the acquired distance information as the distance information 238 for vehicle speed detection in the server memory 230.

In step S711, the server processor 250 may check whether there is an occurrence of a termination event requesting the termination of the distance information calculation function. If there is no occurrence of a termination event, the server processor 250 may repeatedly perform the steps S701 to S709 a specified number of times and determine the distance information 238 between the start point and the end point by using the average of the calculated information. If the termination event occurs, the server processor 250 may terminate the corresponding function.

If only one structure is detected in the surrounding captured images, the server processor 250 may select two points that can be used to detect the speed of the vehicle 41 running on the road 40 among the plurality of points of the structure, and may calculate the distance information 238 by applying the scale to the distance on the map information 236 for the two selected points. If a structure including a point that matches a specific part of the vehicle 41 is not detected in the CCTV captured images about an area of the road 40 including the vehicle 41 and at least one structure, the server processor 250 may generate a control signal for changing the capture direction and provide the signal to the mobile CCTV camera device 100.

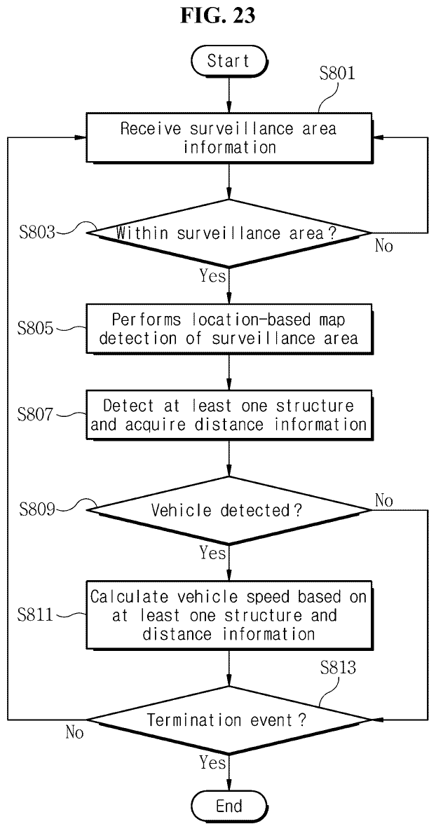

FIG. 23 is a flowchart illustrating a vehicle speed detection method based on a mobile CCTV camera device according to the third embodiment of the present disclosure. The vehicle speed detection method illustrated in FIG. 23 can be performed by the controller 150 of the mobile CCTV camera device 100 illustrated in FIG. 19.

Referring to FIG. 23, in step S801, the controller 150 may receive surveillance area information. The surveillance area information may include location information of an area where a vehicle speed violation occurs but a fixed CCTV camera is not installed. The surveillance area information may include not only location information but also time information for monitoring the area. The surveillance area may be determined by reports from users located around the area or selected as an area where vehicle speed violations frequently occur statistically or where a major accident exceeding a standard may occur. The surveillance area information may be provided by the server processor 250 of the monitoring device 200 or may be provided upon request from a government office requesting surveillance of the area. Upon receiving the surveillance area information, the controller 150 may control the mobile CCTV camera device 100 to move to the area. For example, the controller 150 may activate a navigation function and output a movement route to the surveillance area. If the mobile CCTV camera device 100 is an autonomous vehicle, the controller 150 may control autonomous driving to move the mobile CCTV camera device 100 to the surveillance area.

In step S803, the controller 150 may determine whether the current location is in the surveillance area. In this regard, the controller 150 may obtain location information and compare the obtained location information with the surveillance area information to check whether they match. If the current location is in the surveillance area, the controller 150 may control to move to a location corresponding to the surveillance area information received in the step S801.

When the mobile CCTV camera device 100 is located in the surveillance area, in step S805, the controller 150 may perform location-based map detection of the surveillance area, and in step S807, detect at least one structure and acquire distance information. The steps S805 and S807 may correspond to the steps S701 to S707 described above with reference to FIG. 22. Although FIG. 22 exemplifies that at least one structure detection and distance information acquisition are performed by the monitoring device 200, the corresponding operations may also be performed by the mobile CCTV camera device 100. Alternatively, the mobile CCTV camera device 100 may provide surrounding captured images to the monitoring device 200 and acquire at least one structure and distance information from the monitoring device 200.

Before acquiring the distance information, the controller 150 may search the memory 130 to see if there is pre-stored distance information corresponding to the surveillance area, or request the server processor 250 of the monitoring device 200 to provide distance information for the surveillance area. If the controller 150 has previously performed the process of acquiring and storing the distance information for the surveillance area, or if the server processor 250 of the monitoring device 200 can provide the distance information for the surveillance area, the controller 150 may omit the steps S805 and S807.

In step S809, the controller 150 may determine whether the vehicle 41 is detected. In this regard, the controller 150 may park or hover the mobile CCTV camera device 100 at a predefined location in the surveillance area (e.g., a location where a view that can utilize distance information can be captured), obtain the CCTV captured images of the vehicle 41 driving on the road 40 by using the mounted CCTV camera 101, and check whether the vehicle 41 is detected in the obtained CCTV captured images.

When the vehicle 41 is detected in the CCTV captured images, in step S811, the controller 150 may detect the speed of the vehicle 41 based on at least one structure and distance information. For example, the controller 150 may select a first frame including a vehicle object that matches a point of a first structure (or a first landmark) corresponding to a start reference point selected in relation to distance information among a plurality of structures detected in the CCTV captured images, select a second frame including a vehicle object that matches a point of a second structure (or a second landmark) corresponding to an end reference point, and calculates a travel time of the vehicle 41 between the first and second structures by using the number of frames between the first frame and the second frame. Alternatively, the controller 150 may track a vehicle object that matches a point of the first structure and calculate the time it takes for the vehicle object to reach a point of the second structure as the travel time of the vehicle 41. The controller 150 may detect the speed of the vehicle 41 based on the calculated travel time of the vehicle 41 and the pre-stored distance information 238, and perform alarm processing according to the size of the calculated speed of the vehicle and the preset reference value.

In step S813, the controller 150 may determine whether an event requesting the termination of the vehicle surveillance function has occurred, and if no event has occurred, the controller 150 may return to the step S801 and re-perform the subsequent operations. Meanwhile, it has been described above that the controller 150 of the mobile CCTV camera device 100 performs vehicle surveillance, but the processing related to vehicle surveillance may also be performed by the server processor 250 of the monitoring device 200.

Meanwhile, in FIG. 23, the method for detecting vehicle speed using the mobile CCTV camera device 100 is described, but the present disclosure is not limited thereto. For example, the vehicle speed detection method using the mobile CCTV camera device according to the third embodiment may be modified such that the mobile CCTV camera device 100 collects CCTV captured images (e.g., images from which at least one structure, a designated area of the road 40, and the vehicle 41 can be detected) at a designated location and provides the images to the monitoring device 200, and the monitoring device 200 analyzes the collected CCTV images to detect the speed of the vehicle 41.

While the description contains many specific implementation details, these should not be construed as limitations on the scope of the present disclosure or of what may be claimed, but rather as descriptions of features that may be specific to particular embodiments of particular disclosure.

Also, although the description describes that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

The description shows the best mode of the present disclosure and provides examples to illustrate the present disclosure and to enable a person skilled in the art to make and use the present disclosure. The present disclosure is not limited by the specific terms used herein. Based on the above-described embodiments, one of ordinary skill in the art can modify, alter, or change the embodiments without departing from the scope of the present disclosure.

Accordingly, the scope of the present disclosure should not be limited by the described embodiments and should be defined by the appended claims.

What is claimed is:

1. A speeding vehicle detection method comprising:
by an image processor, receiving a streaming video of a road from an imaging device;
by an object detector, detecting a vehicle through a bounding box in a plurality of frames of the streaming video by using a detection model;
by a speed analyzer, calculating a speed of the detected vehicle by analyzing a movement of the bounding box in frames in which the vehicle is detected from among the plurality of frames; and
by the speed analyzer, determining whether the detected vehicle is speeding based on the calculated speed.

2. The method of claim 1, wherein calculating a speed of the detected vehicle includes:
by the speed analyzer, calculating a travel distance of the vehicle by using a movement distance of the bounding box from a first frame to a last frame among the frames in which the vehicle is detected;
by the speed analyzer, calculating a travel time of the vehicle by applying a frame rate of the streaming video to a number of the frames in which the vehicle is detected; and
by the speed analyzer, calculating the speed of the vehicle based on the calculated travel distance and travel time.

3. The method of claim 2, wherein calculating a travel distance includes:
by the speed analyzer, applying a previously derived homography to convert center coordinates of the bounding box in each of the first and last frames among the frames in which the vehicle is detected into coordinates in a ground map; and
by the speed analyzer, calculating a distance between the converted coordinates in the ground map as the travel distance of the vehicle.

4. The method of claim 3, wherein the travel distance is calculated according to Equation below,
$$D = \sqrt{{( {x}_{2} - {x}_{1} )}^{2} - {( {y}_{2} - {y}_{1} )}^{2}}$$
where D represents the travel distance of the vehicle, x₁ and y₁ are ground coordinates converted from the center coordinates of the bounding box in the first frame among the frames in which the vehicle is detected, and x₂ and y₂ are ground coordinates converted from the center coordinates of the bounding box in the last frame among the frames in which the vehicle is detected.

5. The method of claim 1, further comprising:
before receiving the streaming video,
by a relationship deriver, preparing an image and a ground map corresponding to the image, the image containing a road captured by a camera of the imaging device and being composed of a pixel coordinate system, and the ground map expressing a road indicated by the image and having a two-dimensional coordinate system based on a metric system corresponding to an actual size; and
by the relationship deriver, deriving a homography that converts one coordinates of the image into corresponding coordinates of the ground map, by using the image and the ground map.

6. The method of claim 5, wherein when Equation below is satisfied
$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ]$$
where hᵢⱼ (i≤1, j≤3) denotes a matrix representing the homography, the relationship deriver derives a matrix that minimizes Equation below as the homography
$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2}$$
where (xᵢ, yᵢ) represents the coordinates of the image, and (xᵢ′, yᵢ′) represents the coordinates of the ground map.

7. The method of claim 1, further comprising:
before receiving the streaming video,
by a model generator, preparing learning data including an image and a label, the image containing a vehicle, and the label being a ground-truth box indicating an area occupied by the vehicle in the image;
by the model generator, inputting the image into a detection model whose learning is uncompleted;
by the detection model, detecting a bounding box indicating the area occupied by the vehicle within the image through a plurality of operations for applying untrained inter-layer weights to the input image;
by the model generator, calculating a loss indicating a difference between the detected bounding box and the ground-truth box; and
by the model generator, performing optimization to modify the weight of the detection model so that the loss is minimized.

8. A speeding vehicle detection apparatus comprising:
an image processor receiving a streaming video of a road from an imaging device;
an object detector detecting a vehicle through a bounding box in a plurality of frames of the streaming video by using a detection model; and
a speed analyzer calculating a speed of the detected vehicle by analyzing a movement of the bounding box in frames in which the vehicle is detected from among the plurality of frames, and determining whether the detected vehicle is speeding based on the calculated speed.

9. The apparatus of claim 8, wherein the speed analyzer:
calculates a travel distance of the vehicle by using a movement distance of the bounding box from a first frame to a last frame among the frames in which the vehicle is detected,
calculates a travel time of the vehicle by applying a frame rate of the streaming video to a number of the frames in which the vehicle is detected, and
calculates the speed of the vehicle based on the calculated travel distance and travel time.

10. The apparatus of claim 9, wherein the speed analyzer:
applies a previously derived homography to convert center coordinates of the bounding box in each of the first and last frames among the frames in which the vehicle is detected into coordinates in a ground map, and
calculates a distance between the converted coordinates in the ground map as the travel distance of the vehicle.

11. The apparatus of claim 10, wherein the travel distance is calculated according to Equation below,
$$D = \sqrt{{( {x}_{2} - {x}_{1} )}^{2} - {( {y}_{2} - {y}_{1} )}^{2}}$$
where D represents the travel distance of the vehicle, x₁ and y₁ are ground coordinates converted from the center coordinates of the bounding box in the first frame among the frames in which the vehicle is detected, and x₂ and y₂ are ground coordinates converted from the center coordinates of the bounding box in the last frame among the frames in which the vehicle is detected.

12. The apparatus of claim 8, further comprising:
a relationship deriver:
preparing an image and a ground map corresponding to the image, the image containing a road captured by a camera of the imaging device and being composed of a pixel coordinate system, and the ground map expressing a road indicated by the image and having a two-dimensional coordinate system based on a metric system corresponding to an actual size, and
deriving a homography that converts one coordinates of the image into corresponding coordinates of the ground map, by using the image and the ground map.

13. The apparatus of claim 12, wherein when Equation below is satisfied
$${s}_{i} [ \begin{matrix}{x}_{i}^{′} \\ {y}_{i}^{′} \\ 1\end{matrix} ] \sim H [ \begin{matrix}{x}_{i} \\ {y}_{i} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{i} \\ {y}_{i} \\ 1\end{matrix} ]$$
where hᵢⱼ (i≤1, j≤3) denotes a matrix representing the homography,
the relationship deriver derives a matrix that minimizes Equation below as the homography
$${\sum }_{i} {( {x}_{i}^{′} - \frac{{h}_{11} {x}_{i} + {h}_{12} {y}_{i} + {h}_{13}}{{h}_{31} {x}_{i} + {h}_{32} {y}_{i} + {h}_{33}} )}^{2} - {( {y}_{i}^{′} - \frac{{h}_{21} {x}_{i} + {h}_{22} {y}_{i} + {h}_{23}}{{h}_{31} {x}_{i} + {h}_{32} {y}_{i} + {h}_{33}} )}^{2}$$
where (xᵢ, yᵢ) represents the coordinates of the image, and (xᵢ′, yᵢ′) represents the coordinates of the ground map.

14. The apparatus of claim 8, further comprising:
a model generator:
preparing learning data including an image and a label, the image containing a vehicle, and the label being a ground-truth box indicating an area occupied by the vehicle in the image,
inputting the image into a detection model whose learning is uncompleted,
when the detection model detects a bounding box indicating the area occupied by the vehicle within the image through a plurality of operations for applying untrained inter-layer weights to the input image,
calculating a loss indicating a difference between the detected bounding box and the ground-truth box, and
performing optimization to modify the weight of the detection model so that the loss is minimized.

15. A vehicle speed detection apparatus comprising:
a server communication circuit; and
a server processor functionally connected to the server communication circuit and configured to:
obtain a first CCTV captured image that does not include a vehicle,
set a specific section including a start position and an end position of a lane in the first CCTV captured image,
store distance information of the specific section through an external input,
obtain a second CCTV captured image that includes a vehicle,
measure a travel time of a vehicle object from the start position to the end position by tracking the vehicle object in the second CCTV captured image to, and
calculate speed information of the vehicle based on the measured time and the distance information.

16. The apparatus of claim 15, wherein the server processor is configured to:
select a start reference point object corresponding to the start position and an end reference point object corresponding to the end position from the first CCTV captured image, and
set a section between the start reference point object and the end reference point object as the specific section.

17. A vehicle speed detection apparatus comprising:
a server communication circuit; and
a server processor functionally connected to the server communication circuit and configured to:
obtain CCTV captured images,
select frames of the CCTV captured images at a first interval according to a predefined frame sampling rate,
detect a plurality of frames including at least one reference object having an end that matches with a designated part of a vehicle object among the frames selected at the first interval,
detect a travel time of the vehicle object by identifying intervals of the plurality of frames, and
detect speed information of the vehicle object by using pre-stored distance information between the at least one reference object and the travel time of the vehicle.

18. The apparatus of claim 17, wherein the server processor is configured to:
detect the travel time of the vehicle object based on a frame interval between a first frame including a first reference object having one end matching with the designated part of the vehicle object and a second frame including the first reference object having another end matching with the designated part of the vehicle object, and
detect the speed information of the vehicle object by using pre-stored length information of the first reference object and the travel time of the vehicle.

19. The apparatus of claim 17, wherein the server processor is configured to:
detect the travel time of the vehicle object based on a frame interval between a first frame including a first reference object having one end matching with the designated part of the vehicle object and a second frame including a second reference object having one end matching with the designated part of the vehicle object, and
detect the speed information of the vehicle object by using pre-stored distance information between the first reference object and the second reference object and the travel time of the vehicle.

20. The apparatus of claim 17, wherein the server processor is configured to:
adjust the frame sampling rate in case of failing to detect the reference object having one end matching with the designated part of the vehicle object,
select frames of the CCTV captured images at a second interval narrower than the first interval based on the adjusted frame sampling rate, and
detect the vehicle object and the at least one reference object for the frames selected at the second interval.

21. The apparatus of claim 17, wherein the server processor is configured to:
transmit a control signal to a CCTV camera device providing the CCTV captured images to increase a captured speed by a designated speed in case of failing to detect the reference object having one end matching with the designated part of the vehicle object.

22. A vehicle speed detection method performed by a server processor of a vehicle speed detection apparatus, the method comprising:
obtaining a first CCTV captured image that does not include a vehicle;
setting a specific section including a start position and an end position of a lane in the first CCTV captured image;
storing distance information of the specific section through an external input;
obtaining a second CCTV captured image that includes a vehicle;
measuring a travel time of a vehicle object from the start position to the end position by tracking the vehicle object in the second CCTV captured image to; and
calculating speed information of the vehicle based on the measured time and the distance information.

23. The method of claim 22, wherein setting a specific section includes:
selecting a start reference point object corresponding to the start position and an end reference point object corresponding to the end position from the first CCTV captured image; and
setting a section between the start reference point object and the end reference point object as the specific section.

24. A vehicle speed detection method performed by a server processor of a vehicle speed detection apparatus, the method comprising:
obtaining CCTV captured images;
selecting frames of the CCTV captured images at a first interval according to a predefined frame sampling rate;
detecting a plurality of frames including at least one reference object having an end that matches with a designated part of a vehicle object among the frames selected at the first interval;
detecting a travel time of the vehicle object by identifying intervals of the plurality of frames; and
detecting speed information of the vehicle object by using pre-stored distance information between the at least one reference object and the travel time of the vehicle.

25. The method of claim 24, wherein detecting a travel time includes:
detecting the travel time of the vehicle object based on a frame interval between a first frame including a first reference object having one end matching with the designated part of the vehicle object and a second frame including the first reference object having another end matching with the designated part of the vehicle object, and
wherein detecting speed information includes:
detecting the speed information of the vehicle object by using pre-stored length information of the first reference object and the travel time of the vehicle.

26. The method of claim 24, wherein detecting a travel time includes:
detecting the travel time of the vehicle object based on a frame interval between a first frame including a first reference object having one end matching with the designated part of the vehicle object and a second frame including a second reference object having one end matching with the designated part of the vehicle object, and
wherein detecting speed information includes:
detecting the speed information of the vehicle object by using pre-stored distance information between the first reference object and the second reference object and the travel time of the vehicle.

27. The method of claim 24, wherein detecting a plurality of frames further includes:
adjusting the frame sampling rate in case of failing to detect the reference object having one end matching with the designated part of the vehicle object;
selecting frames of the CCTV captured images at a second interval narrower than the first interval based on the adjusted frame sampling rate; and
detecting the vehicle object and the at least one reference object for the frames selected at the second interval.

28. The method of claim 24, further comprising:
transmitting a control signal to a CCTV camera device providing the CCTV captured images to increase a captured speed by a designated speed in case of failing to detect the reference object having one end matching with the designated part of the vehicle object.

29. A vehicle speed detection apparatus comprising:
a server communication circuit; and
a server processor functionally connected to the server communication circuit and configured to:
obtain a first CCTV captured image including a road and location information of the first CCTV captured image,
detect at least one structure object to be used for speed detection of a vehicle driving on the road based on the first CCTV captured image, and collect map information based on the location information,
match the at least one structure object with at least one structure included in the map information,
obtain length information of the at least one structure from the map information, calculate distance information of the at least one structure object based on length information on the map information, and
store the calculated distance information.

30. The apparatus of claim 29, wherein the server processor is configured to:
detect a first structure object from the first CCTV captured image,
match the first structure object with a first structure on the map information,
obtain a distance value between a first point and a second point of the first structure from the map information, and
calculate distance information of the first structure object by applying a scale of the map information to the distance value.

31. The apparatus of claim 29, wherein the server processor is configured to:
obtain a second CCTV captured image including the vehicle driving on the road,
in the second CCTV captured image, track from a frame where a first point of the first structure object and one point of the vehicle coincide to a frame where a second point of the first structure object and the point of the vehicle coincide, thereby calculating a travel time of the vehicle between the first and second points, and
detect a speed of the vehicle based on the travel time and the distance information.

32. The apparatus of claim 31, wherein the server processor is configured to:
detect the first structure object and the second structure object from the first CCTV captured image,
match the first structure object and the second structure object with the first structure and the second structure on the map information, respectively,
obtain a distance value between one point of the first structure and one point of the second structure from the map information, and
calculate distance information between the first structure object and the second structure object by applying a scale of the map information to the distance value.

33. The apparatus of claim 29, wherein the server processor is configured to:
obtain a second CCTV captured image including the vehicle driving on the road,
in the second CCTV captured image, track from a first frame where one point of the first structure object and one point of the vehicle coincide to a second frame where one point of the second structure object and the point of the vehicle coincide, thereby calculating a travel time of the vehicle between the one point of the first structure object and the one point of the second structure object, and
detect a speed of the vehicle based on the travel time and the distance information.

34. The apparatus of claim 33, wherein the server processor is configured to:
detect the first structure object and the second structure object in the first CCTV captured image by using an edge detection method, and
identify first and second structures having an arrangement matching with the first and second structure objects on the location information of the map information, thereby matching the first and second structure objects to the identified first and second structures.

35. The apparatus of claim 29, wherein the server processor is configured to:
obtain a second CCTV captured image including the vehicle driving on the road,
generate a control signal requesting a change in a CCTV capture direction in case of failing to a frame in which the at least one structure object detected in the second CCTV captured image matches with a specific part of the vehicle object, and
provide the control signal to a mobile CCTV camera device providing the CCTV captured image.

36. A vehicle speed detection method performed by a server processor of a vehicle speed detection apparatus using a mobile CCTV camera device, the method comprising:
obtaining a first CCTV captured image including a road and location information of the first CCTV captured image;
detecting at least one structure object to be used for speed detection of a vehicle driving on the road based on the first CCTV captured image, and collect map information based on the location information;
matching the at least one structure object with at least one structure included in the map information;
obtaining length information of the at least one structure from the map information;
calculating distance information of the at least one structure object based on length information on the map information; and
storing the calculated distance information.

37. The method of claim 36, wherein matching the at least one structure object includes:
detecting a first structure object from the first CCTV captured image;
matching the first structure object with a first structure on the map information;
obtaining a distance value between a first point and a second point of the first structure from the map information; and
calculating distance information of the first structure object by applying a scale of the map information to the distance value.

38. The method of claim 37, further comprising:
obtaining a second CCTV captured image including the vehicle driving on the road;
in the second CCTV captured image, tracking from a frame where a first point of the first structure object and one point of the vehicle coincide to a frame where a second point of the first structure object and the point of the vehicle coincide, thereby calculating a travel time of the vehicle between the first and second points; and
detecting a speed of the vehicle based on the travel time and the distance information.

39. The method of claim 36, wherein matching the at least one structure object includes:
detecting the first structure object and a second structure object from the first CCTV captured image;
matching the first structure object and the second structure object with the first structure and the second structure on the map information, respectively;
obtaining a distance value between one point of the first structure and one point of the second structure from the map information; and
calculating distance information between the first structure object and the second structure object by applying a scale of the map information to the distance value.

40. The method of claim 37, further comprising:
obtaining a second CCTV captured image including the vehicle driving on the road;
in the second CCTV captured image, tracking from a first frame where one point of the first structure object and one point of the vehicle coincide to a second frame where one point of the second structure object and the point of the vehicle coincide, thereby calculating a travel time of the vehicle between the one point of the first structure object and the one point of the second structure object; and
detecting a speed of the vehicle based on the travel time and the distance information.

41. The method of claim 39, wherein matching the first structure object and the second structure object includes:
identifying first and second structures having an arrangement matching with the first and second structure objects on the location information of the map information, thereby matching the first and second structure objects to the identified first and second structures.

42. The method of claim 36, further comprising:
obtaining a second CCTV captured image including the vehicle driving on the road;
generating a control signal requesting a change in a CCTV capture direction in case of failing to a frame in which the at least one structure object detected in the second CCTV captured image matches with a specific part of the vehicle object; and
providing the control signal to a mobile CCTV camera device providing the CCTV captured image.
